(19) United States
(12) Patent Application Publication
(10) Pub. No.: US 2026/0222036 A1
(43) Pub. Date: Jul. 30, 2026

(54) METHODS FOR SIGNALING TYPE II CJT PARAMETER COMBINATION

(71) Applicant: Siva Muruganathan

(72) Inventor: Siva Muruganathan

(21) Appl. No.: 19/148,259

(22) PCT Filed: Jan. 17, 2024
(86) PCT No.: PCT/IB2024/050464

§ 371 Date: Jul. 15, 2025

(51) Int. Cl. H04B 7/06; H04B 7/022

(52) U.S. Cl. CPC H04B 7/0626; H04B 7/022

(57) ABSTRACT

Systems and methods are disclosed that relate to Channel State Information (CSI) feedback corresponding to Coherent Joint Transmission (CJT). In one embodiment, a method performed by a User Equipment (UE) comprises receiving, from a network node, information that configures the UE with a parameter combination list consisting of one or more combinations or hypotheses of values for {L₁, . . . , L_{N}_{_{TRP}}} for a respective set of Channel State Information Reference Signal (CSI-RS) resources {CSI-RS resource 1, . . . , CSI-RS resource N_{TRP}} configured for the UE for CSI feedback corresponding to CJT, wherein Lₙ (n=1, . . . , N_{TRP}) is a number of spatial domain (SD) basis vectors to be selected by the UE from CSI-RS resource n. The method further comprises generating and reporting CSI, in accordance with the received information.

### RELATED APPLICATIONS

This application claims the benefit of provisional patent application Ser. No. 63/480,207, filed Jan. 17, 2023, the disclosure of which is hereby incorporated herein by reference in its entirety.

### TECHNICAL FIELD

The present disclosure relates to a cellular communications system and, more specifically, for Channel State Information (CSI) feedback for Coherent Joint Transmission (CJT).

### BACKGROUND

### Codebook-Based Precoding

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as “MIMO”.

A core component of the Fifth Generation (5G) wireless network or New Radio (NR) is the support of MIMO antenna deployments and MIMO related techniques such as spatial multiplexing. Spatial multiplexing can be used to increase data rates in favorable channel conditions. FIG. 1 shows an example of spatial multiplexing. An information carrying symbol vector s is multiplied by an N_{T}×r precoding matrix or precoder W, which serves to distribute the transmit energy in a subspace of the N_{T} dimensional vector space. The precoding matrix is typically selected from a codebook of possible precoding matrices, and typically indicated by means of a Precoding Matrix Indicator (PMI), which specifies a unique precoding matrix in the codebook for a given number of symbol streams. The r symbols in s each correspond to a MIMO layer and r is referred to as the transmission rank, which equals to the number of columns of the precoder W. In this way, spatial multiplexing is achieved since multiple symbols can be transmitted simultaneously over the same time/frequency Resource Element (RE). The number of symbols r is typically adapted to suit the current channel properties.

NR uses Orthogonal Division Multiplexing (OFDM) in downlink. The received N_{R}×1 vector yₙ at a User Equipment (UE) on a certain RE can be expressed as

$${y}_{n} = {H}_{n} {Ws}_{n} + {e}_{n}$$

where eₙ is a receiver noise/interference vector. The precoder W can be constant over frequency (i.e., wideband), or frequency selective (i.e., per subband).

The precoder W is chosen to match the characteristics of the N_{R}×N_{T} MIMO channel matrix Hₙ, resulting in so-called channel dependent precoding. This is also commonly referred to as closed-loop precoding.

In closed-loop precoding, the UE feeds back recommendations on a suitable precoder to the NR base station, or gNodeB (gNB), in the form of a PMI based on downlink channel measurements. For that purpose, the UE is configured with a Channel State Information (CSI) report configuration including CSI Reference Signals (CSI-RS) for channel measurements and a codebook of candidate precoders. In addition to precoders, the feedback may also include A Rank Indicator (RI) and one or two Channel Quality Indicators (CQIs). RI, PMI, and CQI are part of a CSI feedback. In NR, CSI feedback can be either wideband, where one CSI is reported for the entire channel bandwidth, or frequency-selective, where one CSI is reported for each subband, which is defined as a number of contiguous Physical Resource Blocks (PRBs) ranging between 4-32 PRBs depending on the Band Width Part (BWP) size.

Given the CSI feedback from the UE, the gNB determines the transmission parameters it wishes to use to transmit to the UE, including the precoding matrix, transmission rank, and Modulation and Coding Scheme (MCS).

### 2D Antenna Arrays

Two-dimensional (2D) antenna arrays are widely used, and such antenna arrays can be described by a number of antenna ports, N₁, in a first dimension (e.g., the horizontal dimension), a number of antenna ports, N₂, in the second dimension perpendicular to the first dimension (e.g., the vertical dimension), and a number of polarizations Nₚ. The total number of antenna ports is thus N=N₁N₂Nₚ. The concept of an antenna port is non-limiting in the sense that it can refer to any virtualization (e.g., linear mapping) to the physical antenna elements. For example, pairs of physical antenna elements could be fed the same signal, and hence share the same virtualized antenna port.

An example of a 4×4 (i.e., N₁× N₂,) array with dual-polarized antenna elements (i.e., Nₚ=2) is illustrated below in FIG. 2. In other words, FIG. 2 illustrates an example of a two-dimensional antenna array of dual-polarized antenna elements (Nₚ=2), with N₁=4 horizontal antenna elements and N₂=4 vertical antenna elements.

Precoding may be interpreted as multiplying the signal to be transmitted a set of beamforming weights on the antenna ports prior to transmission. A typical approach is to tailor the precoder to the antenna form factor, i.e., taking into account N₁, N₂ and Nₚ when designing the precoder codebook.

### Channel State Information Reference Signals (CSI-RS)

For CSI measurement and feedback, CSI-RS are defined. A CSI-RS is transmitted on an antenna port at the gNB and is used by a UE to measure downlink channel between the antenna port and each of the UE's receive antenna ports. The transmit antenna ports are also referred to as CSI-RS ports. The supported number of CSI-RS ports in NR are {1,2,4,8,12,16,24,32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain REs in a slot and certain slots. FIG. 3 shows an example of CSI-RS REs for 12 antenna ports, where 1 RE per Resource Block (RB) per port is shown.

In addition, Interference Measurement Resource (IMR) is also defined in NR for a UE to measure interference. An IMR resource contains 4 REs, either 4 adjacent RE in frequency in the same OFDM symbol or 2 by 2 adjacent REs in both time and frequency in a slot. By measuring both the channel based on NZP CSI-RS and the interference based on an IMR, a UE can estimate the effective channel and noise plus interference to determine the CSI. Furthermore, a UE in NR may be configured to measure interference based on one or multiple NZP CSI-RS resource.

### CSI Framework in NR

In NR, a UE can be configured with multiple CSI reporting settings and multiple CSI-RS resource settings. Each resource setting can contain multiple resource sets, and each resource set can contain up to 8 CSI-RS resources. For each CSI reporting setting, a UE feeds back a CSI report.

Each CSI reporting setting contains at least the following information:
A CSI-RS resource setting for channel measurement.
An IMR resource set for interference measurement
Optionally, a CSI-RS resource set for interference measurement
Time-domain behavior, i.e., periodic, semi-persistent, or aperiodic reporting
Frequency granularity, i.e., wideband or subband
CSI parameters to be reported such as RI, PMI, CQI, and CSI-RS Resource Indicator (CRI) in case of multiple CSI-RS resources in a resource set
Codebook types, i.e., type I or II, and codebook subset restriction
Measurement restriction
Subband size. One out of two possible subband sizes is indicated, the value range depends on the bandwidth of the BWP. One CQI/PMI (if configured for subband reporting) is fed back per subband).

In NR, CSI-AperiodicTriggerState is configured in order to trigger aperiodic CSI reports. The CSI-AperiodicTriggerList Information Element (IE) is defined in 3GPP TS 38.331 V17.2.0 as follows. There is list of trigger states which may include up to 128 of CSI-AperiodicTriggerStates. Each trigger state may include up to 16 CSI-AssociatedReportConfigInfo. Each CSI-AssociatedReportConfigInfo contains a reportconfig id which associates it to a CSI-Reportconfig. UE may have up to 48 different CSI-Reportconfigs configured. Each CSI-Reportconfig includes codebookConfig as a field.

### DFT-Based Precoders

A common type of precoding is to use a Discrete Fourier Transform (DFT)-precoder, where the precoder vector used to precode a single-layer transmission using a single-polarized Uniform Linear Array (ULA) with N antennas is defined as

$${w}_{1 D} ( k ) = {u}_{k} = \frac{1}{\sqrt{N}} [ \begin{matrix}{e}^{j 2 π \cdot 0 \cdot \frac{k}{ON}} \\ {e}^{j 2 π \cdot 1 \cdot \frac{k}{ON}} \\ ⋮ \\ {e}^{j 2 π \cdot ( N - 1 ) \cdot \frac{k}{ON}}\end{matrix} ] ,$$

where k=0, 1, . . . . ON−1 is the precoder index and O is an integer oversampling factor. uₖ is also referred to as a one dimensional (1-D) DFT beam with beam index k. If ULA is along the horizontal dimension, each DFT beam points to an azimuth direction. If ULA is along the vertical dimension, each DFT beam points to an elevation direction. Each precoder corresponds to a DFT beam.

A corresponding precoder vector for a two-dimensional Uniform Planar Array (UPA) with N₁ antenna ports in one dimension and N₂ antenna ports in another dimension can be created by taking the Kronecker product of two precoder vectors as

$${w}_{2 D} ( k , l ) = {v}_{k , l} = {u}_{k , 1} ⊗ {u}_{l , 2} ,$$

$$where {u}_{k , 1} = \frac{1}{\sqrt{{N}_{1}}} [ \begin{matrix}{e}^{j 2 π \cdot 0 \cdot \frac{k}{{O}_{1} {N}_{1}}} \\ {e}^{j 2 π \cdot 1 \cdot \frac{k}{{O}_{1} {N}_{1}}} \\ ⋮ \\ {e}^{j 2 π \cdot ( {N}_{1} - 1 ) \cdot \frac{k}{{O}_{1} {N}_{1}}}\end{matrix} ] and {u}_{l , 2} = \frac{1}{\sqrt{{N}_{2}}} [ \begin{matrix}{e}^{j 2 π \cdot 0 \cdot \frac{l}{{O}_{2} {N}_{2}}} \\ {e}^{j 2 π \cdot 1 \cdot \frac{l}{{O}_{2} {N}_{2}}} \\ ⋮ \\ {e}^{j 2 π \cdot ( {N}_{2} - 1 ) \cdot \frac{l}{{O}_{2} {N}_{2}}}\end{matrix} ]$$

are 1-D DFT beams in each of the two dimensions, and O₁ and O₂ are the over sampling factors in the two dimensions associated with N₁ and N₂, respectively. v_{k,l} is also referred to a two-dimension (2-D) DFT beam characterized by two beam indices (k, l), one in each dimension. Each precoder corresponds to a 2D DFT beam.

Extending the DFT precoder for a dual-polarized UPA may then be done as

$${w}_{2 D , DP} ( k , l , ϕ ) = [ \begin{matrix}1 \\ {e}^{j ϕ}\end{matrix} ] ⊗ {w}_{2 D} ( k , l ) = [ \begin{matrix}{w}_{2 D} ( k , l ) \\ {e}^{j ϕ} {w}_{2 D} ( k , l )\end{matrix} ] = [ \begin{matrix}{w}_{2 D} ( k , l ) & 0 \\ 0 & {w}_{2 D} ( k , l )\end{matrix} ] [ \begin{matrix}1 \\ {e}^{j ϕ}\end{matrix} ] ,$$

where e^{jφ} is a co-phasing factor that may be selected from M-PSK alphabet such as QPK with

$$ϕ ∈ \{ 0 , \frac{π}{2} , π , \frac{3 π}{2} \} .$$

A precoder matrix W_{2D,DP} for multi-layer transmission may be created by appending columns of DFT precoder vectors as

$${W}_{2 D , DP} = [ {w}_{2 D , DP} ( {k}_{1} , {l}_{1} , {ϕ}_{1} ) \qquad {w}_{2 D , DP} ( {k}_{2} , {l}_{2} , {ϕ}_{2} ) \qquad … \qquad {w}_{2 D , DP} ( {k}_{r} , {l}_{r} , {ϕ}_{r} ) ] ,$$

where r is the number of transmission layers. Such DFT-based precoders are used for instance in NR Type I CSI feedback, where each layer is associated with 2D DFT beam.

### MU-MIMO

With Multi-User MIMO (MU-MIMO), two or more users in the same cell are co-scheduled on a same time-frequency resource. That is, multiple data streams are transmitted to different UEs at the same time-frequency resource and each UE may be allocated with one or more layers. By transmitting several streams simultaneously, the capacity of the system can be increased.

To avoid across UE or layer interference, Zero-Forcing (ZF) type of precoders may be used in which the feedback precoders associated with all co-scheduled UEs in a same time frequency resource are used together to generate a set of new orthogonal precoders. This requires each of the feedback precoders to be a good representation of underlying channel.

However, a single DFT beam is generally not a good representation of a layer under multipath channel as each layer may be transmitted over multiple paths each corresponding to a DFT beam.

To improve the above single DFT beam based precoder, type II codebook based CSI feedback was introduced in NR Rel-15 and further enhanced in NR Rel-16 and Rel-17. The basic concept is that due to multipath propagation, each layer may contain more than one DFT beam. Hence a better precoder may be created by combining multiple DFT beams for each layer and the UE feeds back both the multiple DFT beams and the combining coefficients.

### NR Rel-15 Type II Codebook

In NR Rel-15, precoders are enhanced based on a type II codebook, in which a precoder is a combination of multiple DFT beams. For each precoder, the UE feeds back the corresponding selected multiple DFT beams and the combination coefficients. A precoder may be reported for each layer and each subband. A common set of DFT beams are selected for all subbands and all layers. The number of DFT beams to be selected is Radio Resource Control (RRC) configured.

For a given 2D cross-polarized antenna array with N₁ antenna ports in one dimension and N₂ antenna ports in another dimension at each polarization, the NR Rel-15 type II codebook-based precoding vector for each layer l∈{1,2} can be expressed as

$$\begin{matrix}{w}_{l} = {W}_{1} {w}_{2 , l} \\ where \\ {W}_{1} = [ \begin{matrix}{v}_{{m}_{1}^{( 0 )} , {m}_{2}^{( 0 )}} , … , {v}_{{m}_{1}^{( L - 1 )} , {m}_{2}^{( L - 1 )}} & 0 \\ 0 & {v}_{{m}_{1}^{( 0 )} , {m}_{2}^{( 0 )}} , … , {v}_{{m}_{1}^{( L - 1 )} , {m}_{2}^{( L - 1 )}}\end{matrix} ] , \\ \{ {v}_{{m}_{1}^{( 0 )} , {m}_{2}^{( 0 )}} , … , {v}_{{m}_{1}^{( L - 1 )} , {m}_{2}^{( L - 1 )}} \}\end{matrix}$$

is a set of size P_{CSI-RS}/2×1 selected 2-D DFT beams, also referred to as spatial domain (SD) basis vectors,

$$\begin{matrix}{P}_{CSI - RS} = 2 {N}_{1} {N}_{2} , {m}_{1}^{( i )} ∈ \{ 0 , 1 , … , {O}_{1} ( {N}_{1} - 1 ) ) and \\ {m}_{2}^{( i )} ∈ \{ 0 , 1 , … , {O}_{2} ( {N}_{2} - 1 ) )\end{matrix}$$

are the beam indices in each dimension for the ith selected DFT beam. L∈{2,3,4} is configured by RRC.
w_{2,l}=[w_{2,l,0}, w_{2,l,1}, . . . , w_{2,l,2L-1}]^{T}, where

$${w}_{2 , l , i} = {p}_{l , i}^{( 1 )} {p}_{l , i}^{( 2 )} {φ}_{l , i}$$

is the combining coefficient associated with the ith beam, and

$${p}_{l , i}^{( 1 )} , {p}_{l , i}^{( 2 )} ,$$

and φ_{l,i} are the wideband amplitude, subband amplitude, and phase of w_{2,l,i}, respectively.
wₗ is expressed in section 5.2.2.2.3 of 3GPP TS 38.214 V15.16.0 as:

$${W}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {{\sum }_{i = 0}}^{2 L - 1} {( {p}_{l , i}^{( 1 )} {p}_{l , i}^{( 2 )} )}^{2}}} [ \begin{matrix}{{\sum }_{i = 0}}^{L - 1} {v}_{{m}_{1}^{( i )} , {m}_{2}^{( i )}} {p}_{l , i}^{( 1 )} {p}_{l , i}^{( 2 )} {φ}_{l , i} \\ {{\sum }_{i = 0}}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] ,$$

$$l = 1 , 2$$

$$\begin{matrix}where {m}_{1}^{( i )} = {O}_{1} {n}_{1}^{( i )} + {q}_{1} , {m}_{2}^{( i )} = {O}_{2} {n}_{2}^{( i )} + {q}_{2} , {q}_{1} ∈ \{ 0 , 1 , … , {O}_{1} - 1 \} , \\ {q}_{2} ∈ \{ 0 , 1 , … , {O}_{2} - 1 \} , {n}_{1} = [ {n}_{1}^{( 0 )} , … , {n}_{1}^{( L - 1 )} ] , {n}_{2} = [ {n}_{2}^{( 0 )} , … , {n}_{2}^{( L - 1 )} ] , \\ {n}_{1}^{( i )} ∈ \{ 0 , 1 , … , {N}_{1} - 1 \} , {n}_{2}^{( i )} ∈ \{ 0 , 1 , … , {N}_{2} - 1 \} , i = 0 , 1 , … , L - 1. \\ {p}_{l}^{( p )} = [ {p}_{l , 0}^{( p )} … {p}_{l , 2 L - 1}^{( p )} ] , p = 1 , 2.\end{matrix}$$

### NR Rel-16 Enhanced Type II (eTypeII) Codebook

The Rel-15 type II codebook is enhanced in NR Rel-16 in which, instead of reporting separate precoders for different subbands, the precoders for all subbands are reported together by using a so called Frequency Domain (FD) basis. It takes advantage of frequency domain channel correlations by representing the precoder changes in frequency domain with a set of frequency domain DFT basis vectors, which will be simply referred to as frequency domain basis vectors. Due to channel correlation in frequency, only a few DFT basis vectors may be used to represent the precoder changes over all the subbands. By doing so, the feedback overhead can be reduced or performance can be improved for the same feedback overhead.

For a given CSI-RS resource with N₁ CSI-RS antenna ports in one dimension and N₂ CSI-RS antenna ports in another dimension, and with two polarizations, the Rel-16 type II codedbook based precoding vectors for each layer l (l=1, . . . , v) and across all subbands can be expressed as:

$${W}_{l} = [ {w}_{l}^{( 0 )} … {w}_{l}^{( {N}_{3} - 1 )} ] = {W}_{1} {\tilde{W}}_{2 , l} {W}_{f , l}^{H} ,$$

where:

$${w}_{l}^{( t )}$$

is a P_{CSI-RS}×1 precoding vector at a PMI subband with subband index t E {0, 1, . . . , N₃−1} for layer l, where P_{CSI-RS}=2N₁N₂ is the number of CSI-RS ports in a configured NZP CSI-RS resource;
N₃=N_{SB}×R is the number of subbands for PMI, where N_{SB} is the number of CQI subbands and R∈{1,2} is a scaling factor, both N_{SB} and R are RRC configured
W₁ is the same as in Rel-15 type II codebook and contains a set of selected beams or SD basis vector

$${W}_{f , l} = [ {y}_{l}^{( 0 )} , {y}_{l}^{( 1 )} , … , {y}_{l}^{( {M}_{v} - 1 )} ]$$

is a size N₃×Mᵥ frequency domain (FD) compression matrix for layer l comprising Mᵥ selected FD basis vectors and

$$\begin{matrix}{y}_{l}^{( f )} = {[ {y}_{0 , l}^{( f )} , {y}_{1 , l}^{( f )} , … , {y}_{{N}_{3} - 1 , l}^{( f )} ]}^{T} and {y}_{t , l}^{( f )} = {e}^{- j 2 π {tn}_{3 , l}^{( f )} / {N}_{3}} , \\ t = 0 , 1 , … , {N}_{3} - 1 , {n}_{3 , l}^{( f )} ∈ \{ 0 , 1 , … , {N}_{3} - 1 \} . {M}_{v} = ⌈ {p}_{v} \frac{{N}_{3}}{R} ⌉\end{matrix}$$

is the number of selected FD basis vectors, which depends on the rank v and the RRC configured parameter pᵥ. Supported values of pᵥ can be found in Table 1.
   For N₃≤19, a one-step free selection is used.
      For each layer, the selected FD basis vectors are indicated with a

$$⌈ {log}_{2} ( \begin{matrix}{N}_{3} - 1 \\ {M}_{v} - 1\end{matrix} ) ⌉$$

bit combinatorial indicator. In 3GPP TS 38.214, the combinatorial indicator is given by the index i_{1,6,l}, which is reported by UE to the gNB.
For N₃≥19, a two-step selection with layer-common intermediary subset (IntS) is used.
   In the first step, a window-based layer-common IntS selection is used, which is parameterized by Mᵢₙᵢₜᵢₐₗ. The IntS consists of FD basis vectors {mod (Mᵢₙᵢₜᵢₐₗ+n, N₃), n=0, 1, . . . , 2Mᵥ−1}. In 3GPP TS 38.214, the selected IntS is reported by the UE to the gNB via the parameter i_{1,5}, which is reported per layer as part of the PMI reported.
   In the second step, the selected FD basis vectors are indicated with an

$$⌈ {log}_{2} ( \begin{matrix}2 {M}_{v} - 1 \\ {M}_{v} - 1\end{matrix} ) ⌉$$

-bit combinatorial indicator for each layer. In TS 38.214, the combinatorial indicator is given by the index i_{1,6,l}, which is reported by UE to the gNB.
\tilde{W}_{2,1}=[\tilde{w}_{l,i,f}, i=0, 1, . . . , 2L−1, f=0, 1, . . . , Mᵥ−1] is a size 2L×Mᵥ coefficient matrix. For layer l, only a subset of

$${K}_{l}^{NZ} \leq {K}_{0}$$

coefficients are non-zero and reported by the UE. The remaining

$$2 {LM}_{v} - {K}_{l}^{NZ}$$

non-reported coefficients are considered zero.
   K₀=┌β×2LM₁┐ is the maximum number of non-zero coefficients per layer, where β is a RRC configured parameter. Supported β values are shown in Table 1.
   For v∈{2, 3, 4}, the total number of non-zero coefficients summed across all layers,

$${K}_{tot}^{NZ} = {\sum }_{l = 1}^{v} {K}_{l}^{NZ} ,$$

shall satisfy

$${K}_{tot}^{NZ} \leq 2 {K}_{0} .$$

Selected coefficient subset for each layer is indicated with

$${K}_{l}^{NZ}$$

1s in a size 2LMᵥ bitmap, i_{1,7,l}.
The strongest coefficient of layer l (whose amplitude and phase are not reported) is identified by i_{1,8,l},∈{0, 1, . . . , 2L−1}.
The amplitude coefficients in W_{2,l} are indicated by i_{2,3,l} and i_{2,4,l}, and the phase coefficients in W_{2,l} are indicated by i_{2,5,l}.

The above is described in 3GPP TS 38.214, section 5.2.2.2.5, where

$${w}_{l}^{( t )}$$

is expressed as follows:

$${W}_{{q}_{1} , {q}_{2} , {n}_{1} , {n}_{2} , {n}_{3 , l} , {p}_{l}^{( 1 )} , {p}_{l}^{( 2 )} , {i}_{2 , 5 , l} t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{v} - 1} {y}_{t , l}^{( f )} {p}_{l , i + L , f}^{( 2 )} {φ}_{l , i + L , f}\end{matrix} ] , l = 1 , 2 , 3 , 4 ,$$

$${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2}$$

where

$$\{ {q}_{1} , {q}_{2} , {n}_{1} , {n}_{2} , {n}_{3 , l} , {p}_{l}^{( 1 )} , {p}_{l}^{( 2 )} , {i}_{2 , 5 , l} \}$$

are quantities reported by a UE and
{q₁, q₂} are reported via the parameter i_{1,1} while {n₁, n₂} are reported via the parameter i_{1,2}.

$$\cdot {n}_{3 , l} = [ {n}_{3 , l}^{( 0 )} , … , {n}_{3 , l}^{( {M}_{v} - 1 )} ] , {n}_{3 , l}^{( f )} ∈ \{ 0 , 1 , … , {N}_{3} - 1 \} ,$$

are the indices of the M_{υ} FD basis vectors

$$\{ {y}_{l}^{( 0 )} , {y}_{l}^{( 1 )} , … , {y}_{l}^{( {M}_{ν} - 1 )} \}$$

$$\cdot {p}_{l}^{( 1 )} = [ \begin{matrix}{p}_{l , 0}^{( 1 )} & {p}_{l , 1}^{( 1 )}\end{matrix} ]$$

polarizations, and

$${P}_{l , i , f}^{( 2 )}$$

is the subband amplitude of the coefficient \tilde{w}_{l,i,f}, where

$${p}_{l , i , f}^{( 2 )} is part of {p}_{l}^{( 2 )} = [ {p}_{l , 0}^{( 2 )} … {p}_{l , {M}_{v} - 1}^{( 2 )} ] , {p}_{l , f}^{( 2 )} = [ {p}_{l , 0 , f}^{( 2 )} … {p}_{l , 2 L - 1 , f}^{( 2 )} ] ,$$

$${φ}_{l , i , f} = {e}^{j \frac{2 π {c}_{l , i , f}}{16}}$$

is phase of the coefficient \tilde{w}_{l,i,f}, where c_{l,i,f}∈{0, . . . , 15} is part of i_{2,5,l}=[c_{l,0} . . . c_{l,M}_{_{υ}}₋₁], c_{l,f}=[c_{l,0,f} . . . c_{l,2L-1,f}]

TABLE 1
Codebook parameter configurations for L, β and
p_{υ} for Rel-16 enhanced type II codebook

| | | p_{υ} | | |
|---|---|---|---|---|
| paramCombination-r16 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

### NR Rel-16 Enhanced Type II Port Selection Codebook

The enhanced Type II (eType II) Port Selection (PS) codebook was also introduced in Rel-16, which is intended to be used for beamformed CSI-RS, i.e., each CSI-RS port corresponds a 2D spatial beam. Based on the measurement, the UE selects the best CSI-RS ports and recommends a rank, a precoding matrix, and a CQI conditioned on the rank and the precoding matrix to the gNB.

The precoding matrix comprises linear combinations of the selected CSI-RS ports. For a given transmission layer l, with l∈{1, . . . , v} and v being the rank indicated by the rank indicator (RI), the precoder matrix has the same form as Rel16 enhanced Type II codebook, i.e.

$${W}_{l} = [ \begin{matrix}{w}_{l}^{( 0 )} & … & {w}_{l}^{( {N}_{3} - 1 )}\end{matrix} ] = {W}_{1} {\tilde{W}}_{2 , l} {W}_{f , l}^{H} ,$$

\tilde{W}_{2,l} and W_{f,l} are the same as in Rel-16 enhanced Type II codebook. The main difference is on W₁, which is a size P_{CSI-RS}×2L port selection matrix given by W₁=

$$[ \begin{matrix}{e}_{{m}^{( 0 )}} , … , {e}_{{m}^{( L - 1 )}} & 0 \\ 0 & {e}_{{m}^{( 0 )}} , … , {e}_{{m}^{( L - 1 )}}\end{matrix} ] ,$$

where eₘ_{⁽ⁱ⁾}= [0, . . . , 0,1,0, . . . , 0]^{T}, i=0, 1, . . . , L−1 is a port selection vector of size

$$\frac{{P}_{CSI - RS}}{2} \times 1$$

and contains one element with value of one at location

$${m}^{( i )} ∈ \{ 0 , 1 , … , ⌈ \frac{{P}_{CSI - RS}}{2 d} ⌉ - 1 \}$$

indicating the selected CSI-RS port while all the other elements are with values of zeros, e.g., e₀= [1,0, . . . , 0]^{T} and e_{P}_{_{CSI-RS/2}}=[0,0, . . . , 0,1] T. L is the number of selected CSI-RS ports from each polarization and the same ports are selected for both polarizations. Supported L values can be found in Table 2. The value of d is configured with the higher layer parameter portSelectionSamplingSize, where d∈{1, 2, 3, 4} and

$$d < min ( \frac{{P}_{CSI - RS}}{2} , L ) .$$

Selected CSI-RS ports are indicated by which is

$${i}_{1 , 1} ∈ \{ 0 , 1 , … , ⌈ \frac{{P}_{CSI - RS}}{2 d} ⌉ - 1 \} ,$$

which is reported by the UE to gNB. i_{1,2} is irrelevant and thus is not reported.

TABLE 2
Table 5.2.2.2.6-1: Codebook parameter configurations for L, β and
p_{υ} for Rel-16 enhanced port selection type II codebook

| | | p_{υ} | | |
|---|---|---|---|---|
| paramCombination-r16 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

For Rel-16 Enhanced Type II CSI feedback, a CSI report comprises of two parts. Part 1 has a fixed payload size and is used to identify the number of information bits in Part 2. Part 1 contains RI, CQI, and an indication of the overall number of non-zero amplitude coefficients across layers, i.e.,

$${K}_{tot}^{N Z} ∈ \{ 1 , 2 , … , 2 {K}_{0} \} .$$

Part 2 contains the PMI. Part 1 and 2 are separately encoded.

### NR Rel-17 Further Enhanced Type II Port Selection Codebook

The Rel-16 port selection codebook is further enhanced in Rel-17, in which it is assumed that each CSI-RS port is associated to a channel delay and different channel delays are associated to different CSI-RS ports. It is also assumed that the delays associated to the CSI-RS ports have been pre-compensated before being transmitted and, thus, only one or two frequency domain basis vectors may be selected by a UE, i.e., Mᵥ∈{1,2}. The one or two FD basis vectors are the same for all layers, therefore M is used instead of Mᵥ.

The number, L, of CSI-RS ports or beams at each polarization to be selected is indirectly configured as L=αP_{CSI-RS}/2, where parameter α is configured by RRC as shown in Table 3. The 2L total CSI-RS ports are selected from P_{CSI-RS} ports based on L port selection vectors, eₘ_{⁽ⁱ⁾}, i=0, 1, . . . , L−1, which are identified by

$$m = [ {m}^{( 0 )} … {m}^{( L - 1 )} ]$$

$${m}^{( i )} ∈ \{ 0 , 1 , … , \frac{{P}_{CSI - RS}}{2} - 1 \}$$

which are indicated by the index i_{1,2}, where

$${i}_{1 , 2} ∈ \{ 0 , 1 , … , ( \begin{matrix}{P}_{CSI - RS} / 2 \\ L\end{matrix} ) - 1 \} .$$

The M selected FD basis vectors,

$${[ {y}_{0}^{( f )} , {y}_{1}^{( f )} , … , {y}_{{N}_{3} - 1}^{( f )} ]}^{T} ,$$

f∈{0, . . . , M−1}, are identified by n₃, and where

$${n}_{3} = [ \begin{matrix}{n}_{3}^{( 0 )} & … & {n}_{3}^{( M - 1 )}\end{matrix} ]$$

$${n}_{3}^{( f )} ∈ \{ \begin{matrix}\{ 0 \} & M = 1 \\ \{ 0 , 1 , … , min ( N , {N}_{3} ) - 1 \} & M = 2\end{matrix}$$

with the indices f∈{0, . . . , M−1} assigned such that

$${n}_{3}^{( f )}$$

increases with f. n₃ is indicated by the index i_{1,6}.

TABLE 3
Codebook parameter configurations for α, M and β for
Rel-17 further enhanced type II port selection codebook

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | 3/4 | ½ |
| 7 | 2 | 1 | ½ |
| 8 | 2 | 1 | ¾ |

### Coherent Joint PDSCH Transmission from Multiple TRPs

In NR Rel-18, it has been agreed to support downlink Coherent Joint Transmission (CJT) from multiple Transmission and Reception Points (TRPs) by extending Rel-16 and Rel-17 enhanced type II codebook across multiple TRPs. In case of CJT, each layer of a Physical Downlink Shared Channel (PDSCH) is transmitted from multiple TRPs. An example of CJT over two TRPs is shown in FIG. 4, where a PDSCH with two layers is transmitted from two TRPs by applying two different precoding matrices to the PDSCH at TRP1 and TRP2. The two precoders are designed such that, for each layer, the signals received from the two TRPs are phase aligned at the UE and thus are coherently combined at the UE.

Extension of NR Rel-16 type II codebook to CJT has been discussed in 3GPP and two modes of codebook structures for supporting CJT have been agreed as follows:
Mode 1: Per-TRP/TRP-group SD/FD basis selection which allows independent FD basis selection across N TRPs/TRP groups. Example formulation (N=number of TRPs or TRP groups):

$$W = [ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

Mode 2: Per-TRP/TRP group (port-group or resource) SD basis selection and joint/common (across N TRPs) FD basis selection. Example formulation (N=number of TRPs or TRP groups):

$$W = [ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ]$$

In the above formulations, each TRP/TRP group corresponds to one CSI-RS resource.

In both mode 1 and mode 2, the precoding matrix W for CJT is very similar to that in Rel-16 enhanced type II codebook. One difference is that now the spatial beams are selected from multiple TRPs instead of from a single TRP. In Mode 1, FD basis vectors are also selected in a per TRP basis, while in Mode 2, a common set of FD basis vectors are selected for all TRPs.

In this disclosure, N is used to denote the number of selected TRPs (e.g., the number of TRPs selected by the UE) for Type II CJT CSI, while N_{TRP} is used to denote the total number of configured TRPs (i.e., CSI-RS resources) by the network to the UE. For Type II CJT CSI reporting, the UE may select all the configured TRPs (i.e., N=N_{TRP}), or subset of the selected TRPs (i.e., N<N_{TRP}).

For N_{TRP} configured CSI-RS resources configured as channel measurement resources for Type II CJT CSI reporting, it has been agreed in 3GPP that the number of spatial domain (SD) basis vectors to be selected for each of the N_{TRP} configured CSI-RS resources is higher-layer configured by the gNB. Letting Ln be the number of SD basis vectors to be selected from CSI-RS resource n, the number of SD basis vectors to be selected across all the CSI-RS resources is the n given by {L₁, . . . , L_{N}_{_{TRP}}}. It is agreed in 3GPP that the gNB configures a set of N_{L} combinations or hypotheses of values for {L₁, . . . , L_{N}_{_{TRP}}}, and the UE selects one of the N_{L} configured combinations and reports the selected hypothesis to the gNB.

### SUMMARY

Systems and methods are disclosed that relate to Channel State Information (CSI) feedback corresponding to Coherent Joint Transmission (CJT). In one embodiment, a method performed by a User Equipment (UE) comprises receiving, from a network node, information that configures the UE with a parameter combination list consisting of one or more combinations or hypotheses of values for {L₁, . . . , L_{N}_{_{TRP}}} for a respective set of Channel State Information Reference Signal (CSI-RS) resources {CSI-RS resource 1, . . . , CSI-RS resource N_{TRP}} configured for the UE for CSI feedback corresponding to CJT, wherein Lₙ (n=1, . . . , N_{TRP}) is a number of spatial domain (SD) basis vectors to be selected by the UE from CSI-RS resource n. The method further comprises generating and reporting CSI, in accordance with the received information.

In one embodiment, the CSI feedback corresponding to CJT is for an enhanced Type II codebook. In one embodiment, a parameter β is configured together with each {Lₙ, n=1, . . . , N_{TRP}} hypothesis, where the parameter β is used to determine the maximum number of non-zero coefficients in the enhanced Type II codebook. In another embodiments, both parameters β and pᵥ are configured together with each {Lₙ, n=1, . . . , N_{TRP}} hypothesis, where the parameter (is used to determine the maximum number of non-zero coefficients in the enhanced Type II codebook, and the parameter pᵥ is used to determine the number of frequency domain (FD) basis vectors. In another embodiment, the method further comprises, receiving, from the network node, information that configures the UE with parameter β and/or parameter pᵥ, separately from the information that configures the UE with the parameter combination list, where the parameter β is used to determine the maximum number of non-zero coefficients in the enhanced Type II codebook, and the parameter pᵥ is used to determine the number of FD basis vectors.

In one embodiment, the information that configures the UE with the parameter combination list comprises the parameter combination list.

In one embodiment, the information that configures the UE with the parameter combination list comprises an index or value that is mapped to the parameter combination list via a predefined or configured table.

In one embodiment, the information that configures the UE with the parameter combination list is part of a CodebookConfig Information Element (IE).

In one embodiment, the information that configures the UE with the parameter combination list is part of a codebook configuration within a CSI report configuration.

In one embodiment, the information that configures the UE with the parameter combination list is part of a CSI-AperiodicTriggerStateList IE. In one embodiment, the number of combinations or hypotheses in the parameter combination list corresponding to each of multiple CSI-AssociatedReportConfigInfos included in the CSI-AperiodicTriggerStateList IE is the same. In another embodiment, the number of combinations or hypotheses in the parameter combination list corresponding to each of multiple CSI-AssociatedReportConfigInfos included in the CSI-AperiodicTriggerStateList IE is different. In one embodiment, the number of combinations or hypotheses is a UE capability and is reported to the network by the UE.

In one embodiment, the information that configures the UE with the parameter combination list is part of a CSI-SemiPersistentOnPUSCH-TriggerState.

In one embodiment, the generated and reported CSI is for semi-persistent CSI report on Physical Uplink Shared Channel (PUSCH) triggered or activated by Downlink Control Information (DCI) format 0_1 or DCI format 0_2, and the information that configures the UE with the parameter combination list is part of a CSI-SemiPersistentOnPUSCH-TriggerState associated to a CSI report configuration.

Corresponding embodiments of a UE are also disclosed. In one embodiment, a UE is adapted to receive, from a network node, information that configures the UE with a parameter combination list consisting of one or more combinations or hypotheses of values for {L₁, . . . , L_{N}_{_{TRP}}} for a respective set of CSI-RS resources {CSI-RS resource 1, . . . , CSI-RS resource N_{TRP}} configured for the UE for CSI feedback corresponding to CJT, wherein Lₙ (n=1, . . . , N_{TRP}) is a number of spatial domain, SD, basis vectors to be selected by the UE from CSI-RS resource n. The UE is further adapted to generate and report CSI, in accordance with the received information.

In one embodiment, a UE comprises communication interface comprising a transmitter and a receiver, and processing circuitry associated with the communication interface, the processing circuitry configured to cause the UE to receive, from a network node, information that configures the UE with a parameter combination list consisting of one or more combinations or hypotheses of values for {L₁, . . . , L_{N}_{_{TRP}}} for a respective set of CSI-RS resources {CSI-RS resource 1, . . . , CSI-RS resource N_{TRP}} configured for the UE for CSI feedback corresponding to CJT, wherein Lₙ (n=1, . . . , N_{TRP}) is a number of spatial domain, SD, basis vectors to be selected by the UE from CSI-RS resource n. The processing circuitry is further configured to cause the UE to generate and report CSI, in accordance with the received information.

Embodiments of a method performed by a network node are also disclosed. In one embodiment, a method performed by a network node comprises sending, to a User Equipment, UE, information that configures the UE with a parameter combination list consisting of one or more combinations or hypotheses of values for {L₁, . . . , L_{N}_{_{TRP}}} for a respective set of Channel State Information Reference Signal, CSI-RS, resources {CSI-RS resource 1, . . . , CSI-RS resource N_{TRP}} configured for the UE for Channel State Information, CSI, feedback corresponding to Coherent Joint Transmission, CJT, wherein Lₙ (n=1, . . . , N_{TRP}) is a number of spatial domain, SD, basis vectors to be selected by the UE from CSI-RS resource n.

Corresponding embodiments of a network node are also disclosed. In one embodiment, a network node for a radio access network of a cellular communications system is adapted to send, to a UE, information that configures the UE with a parameter combination list consisting of one or more combinations or hypotheses of values for {L₁, . . . , L_{N}_{_{TRP}}} for a respective set of CSI-RS resources {CSI-RS resource 1, . . . , CSI-RS resource N_{TRP}} configured for the UE for CSI feedback corresponding to CJT, wherein Lₙ (n=1, . . . , N_{TRP}) is a number of SD basis vectors to be selected by the UE from CSI-RS resource n.

In one embodiment, a network node for a radio access network of a cellular communications system comprises a communication interface and processing circuitry associated to the communication interface. The processing circuitry is configured to cause the network node to send, to a UE, information that configures the UE with a parameter combination list consisting of one or more combinations or hypotheses of values for {L₁, . . . , L_{N}_{_{TRP}}} for a respective set of CSI-RS resources {CSI-RS resource 1, . . . , CSI-RS resource N_{TRP}} configured for the UE for CSI feedback corresponding to CJT, wherein Lₙ (n=1, . . . , N_{TRP}) is a number of SD basis vectors to be selected by the UE from CSI-RS resource n.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of spatial multiplexing;

FIG. 2 illustrates an example of a 4×4 (i.e., N₁×N₂,) antenna array with dual-polarized antenna elements (i.e., Nₚ=2);

FIG. 3 shows an example of Channel State Information Reference Signal (CSI-RS) Resource Elements (REs) for 12 antenna ports, where 1 RE per Resource Block (RB) per port is shown;

FIG. 4 illustrates an example of Coherent Joint Transmission (CJT) over two Transmission and Reception Points (TRPs);

FIGS. 5A-5C illustrate an example embodiment showing configuration of parameter combination list for aperiodically triggered Type II Channel State Information (CSI);

FIG. 6 illustrates an example embodiment showing configuration of parameter combination list for semi-persistently triggered Type II CSI;

FIG. 7 illustrates an example embodiment showing configuration of parameter combination list as part of codebook configuration;

FIG. 8 illustrates an example embodiment of configuring Lₙ combinations together with β;

FIG. 9 illustrates an example embodiment of configuring both parameters β and pᵥ together with each {Lₙ, n=1, . . . , N_{TRP}} hypothesis;

FIG. 10 illustrates an example embodiment of a table that predefines {Lₙ, n=1, . . . , N_{TRP}} combination hypotheses together with β and pᵥ where each row of the table corresponds to one {Lₙ} combination hypothesis together with associated β and pᵥ values;

FIG. 11 illustrates an example of configuring a bit string to select a subset or a whole set of the prespecified parameter combination table;

FIG. 12 illustrates another example embodiment of a table the predefines the possible {Lₙ} hypothesis;

FIG. 13 illustrates an example embodiment of an explicit identifier (ID) for each value/combination or each joint configuration;

FIG. 14 illustrates an example embodiment of an explicit identifier (ID) for each value/combination or each joint configuration;

FIG. 15 illustrates the operation of a network node and a User Equipment (UE) to support extension of (e.g., New Radio (NR) Release 16) type II codebook to CJT, in accordance with at least some of the embodiments described herein;

FIG. 16 shows an example of a communication system in accordance with some embodiments;

FIG. 17 shows a UE in accordance with some embodiments;

FIG. 18 shows a network node in accordance with some embodiments;

FIG. 19 is a block diagram of a host, which may be an embodiment of the host of Figure, in accordance with various aspects described herein;

FIG. 20 is a block diagram illustrating a virtualization environment in which functions implemented by some embodiments may be virtualized; and

FIG. 21 shows a communication diagram of a host communicating via a network node with a UE over a partially wireless connection in accordance with some embodiments.

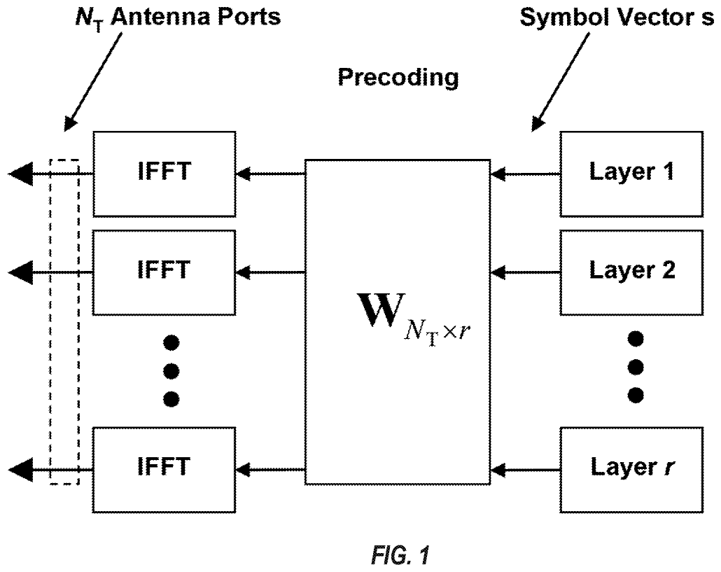

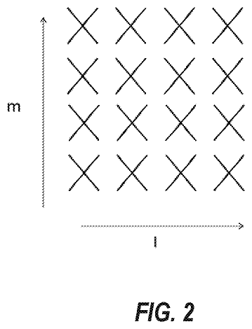

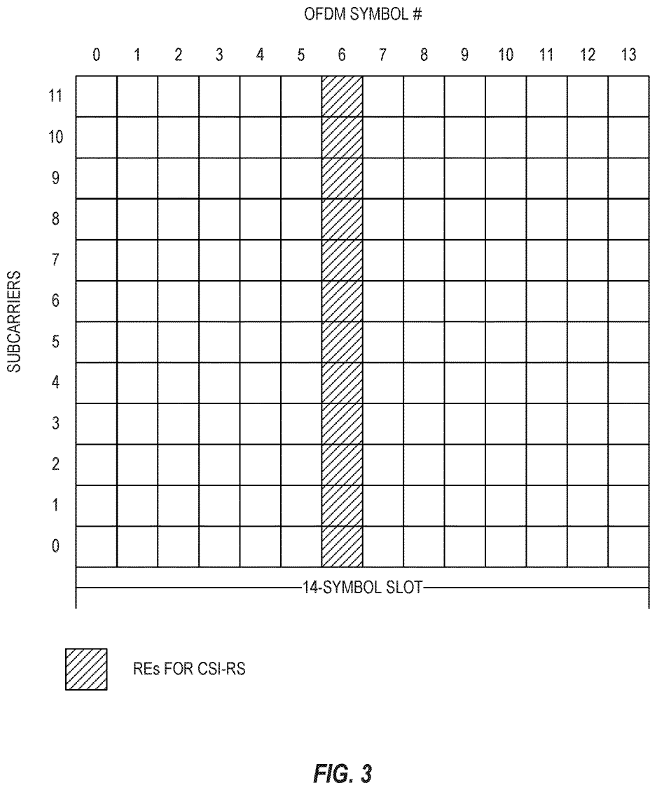

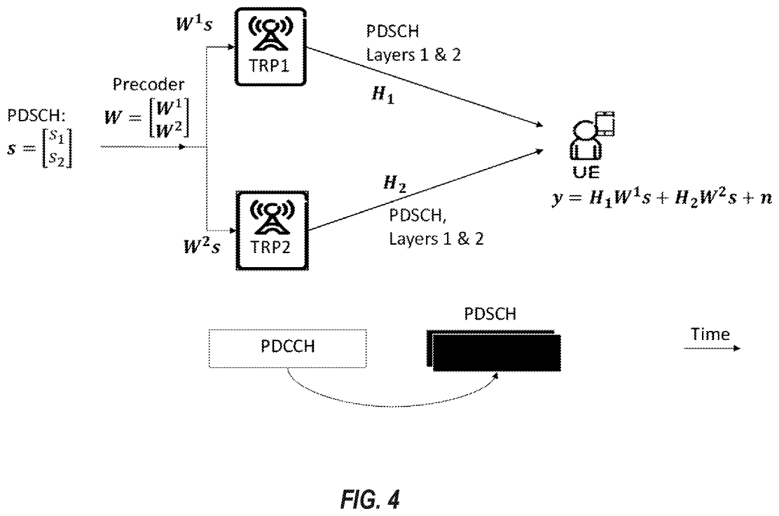

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s) with respect to downlink (i.e., Physical Downlink Shared Channel (PDSCH)) Coherent Joint Transmission (CJT) from multiple Transmission and Reception Points (TRPs) in a 3^{rd} Generation Partnership Project (3GPP) network. As described in the Background section above, for N_{TRP} configured Channel State Information Reference Signal (CSI-RS) resources configured as channel measurement resources for Type II CJT Channel State Information (CSI) reporting, it has been agreed in 3GPP that the number of Spatial Domain (SD) basis vectors to be selected for each of the N_{TRP} configured CSI-RS resources is higher-layer configured by the New Radio (NR) base station, or gNodeB (gNB). Letting Lₙ be the number of SD basis vectors to be selected from CSI-RS resource n, the number of SD basis vectors to be selected across all the CSI-RS resources is the n given by {L₁, . . . , L_{N}_{_{TRP}}}. It is agreed in 3GPP that the gNB configures a set of Ny combinations or hypotheses of values for {L₁, . . . , L_{N}_{_{TRP}}}, and the User Equipment (UE) selects one of the N_{L} configured combinations and reports the selected combination to the gNB. Although it has been agreed in 3GPP that the gNB configures a set of N_{L} combinations or hypotheses of values for {L₁, . . . , L_{N}_{_{TRP}}}, the details of how exactly these N_{L} combinations or hypotheses are signaled to the UE is not known and hence is an open problem to be solved.

Certain aspects of the disclosure and their embodiments may provide solutions to these or other challenges. Several embodiments are presented in this disclosure. Some example embodiments are as follows:
Embodiment 1: The network (e.g., a network node such as, e.g., a gNB) configures a UE with a parameter combination list including (e.g., consisting of) N_{L} combinations or hypotheses of values for {L₁, . . . , L_{N}_{_{TRP}}} as part of CSI-AssociatedReportConfigInfo. Note that the phrase “including (e.g., consisting of”) is used herein as a generalization to cover either “including” or “consisting of”. This embodiment allows different combinations or hypotheses to be configured to different CSI-AssociatedReportConfigInfos that are associated with the same Type II CJT report configuration. The network has the flexibility to trigger different combinations or hypotheses by different aperiodic CSI trigger states. This embodiment is useful for aperiodically triggered Type II CJT reports.
Embodiment 2: The network (e.g., a network node such as, e.g., a gNB) configures a UE with a parameter combination list including (e.g., consisting of) N_{L} combinations or hypotheses of values for {L₁, . . . , L_{N}_{_{TRP}}} as part of CSI-SemiPersistentOnPUSCH-TriggerState. This embodiment allows different combinations or hypotheses to be configured to different CSI-SemiPersistentOnPUSCH-TriggerStates that are associated with the same Type II CJT report configuration. The network has the flexibility to activate different combinations or hypotheses by triggering different semi-persistent CSI trigger states when activating the semi-persistent type II CSI report on Physical Uplink Shared Channel (PUSCH). This embodiment is useful for semi-persistently activated Type II CJT reports on PUSCH.
Embodiment 3: The network (e.g., a network node such as, e.g., a gNB) configures a UE with a parameter combination list consisting of N_{L} combinations or hypotheses of values for {L₁, . . . , L_{N}_{_{TRP}}} as part of CodebookConfig. This embodiment can be an alternative to Embodiment 1 and Embodiment 2. This embodiment is useful for semi-persistently activated Type II CJT reports on PUSCH or aperiodically triggered Type II CJT reports on PUSCH.
Embodiment 4: Allows (e.g., the network or network node allows) other type II CJT codebook parameters (i.e., pᵥ and/or β) to be configured together with parameter combination of N_{L} combinations or hypotheses of values for {L₁, . . . , L_{N}_{_{TRP}}}. This embodiment can be combined with Embodiments 1, 2, and/or 3. Note that, as defined in 3GPP specifications, the parameter β is used to determine the maximum number of non-zero coefficients in the enhanced Type II codebook, and the parameter pᵥ is used to determine the number of FD basis vectors.
Embodiment 5: Covers several options for separately configuring pᵥ, β and parameter combination of N_{L} combinations or hypotheses of values for {L₁, . . . , L_{N}_{_{TRP}}}. These embodiments can be considered as alternatives to Embodiment 4.

Certain embodiments may provide one or more of the following technical advantage(s). Embodiments of the present disclosure provide solutions for how to signal a parameter combination list including (e.g., consisting of) N_{L} combinations or hypotheses of values for {L₁, . . . , L_{N}_{_{TRP}}}. Embodiments of the proposed solutions may also allow flexibility for the network to flexibility to trigger/activate different combinations or hypotheses of values for {L₁, . . . , L_{N}_{_{TRP}}} thus simplifying CSI computation at the UE and reducing the needed CSI feedback overhead (i.e., by choosing the appropriate parameter combinations flexibly).

### Embodiment 1: Configuration of Parameter Combination List for Aperiodically Triggered Type II CSI

In one embodiment, a parameter combination list including (e.g., consisting of) N_{L} combinations or hypotheses is configured as part of the CSI-AperiodicTriggerStateList information element (IE). Note that the CSI-AperiodicTriggerStateList IE is as defined in 3GPP TS 38.331 (see, e.g., V17.2.0).

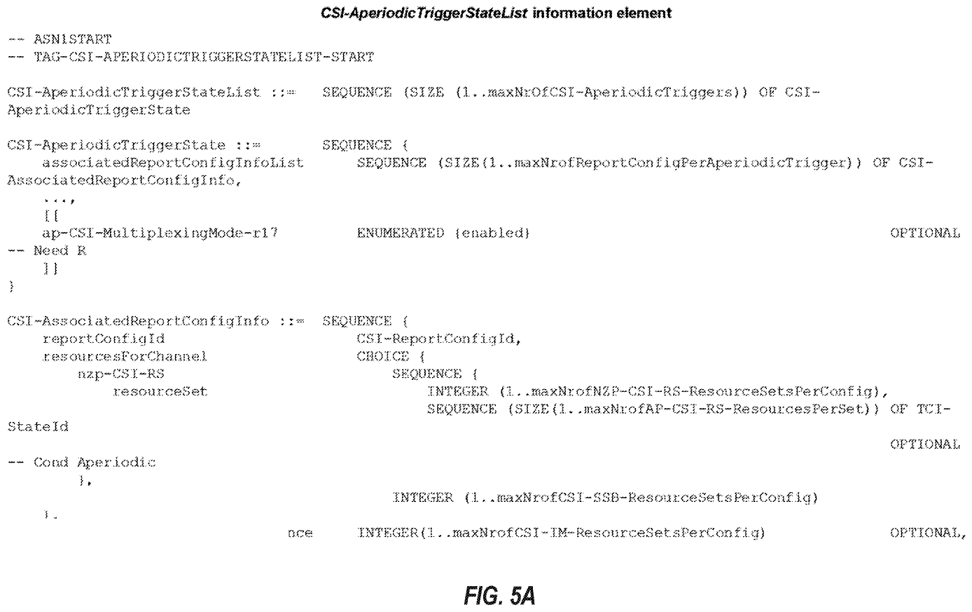

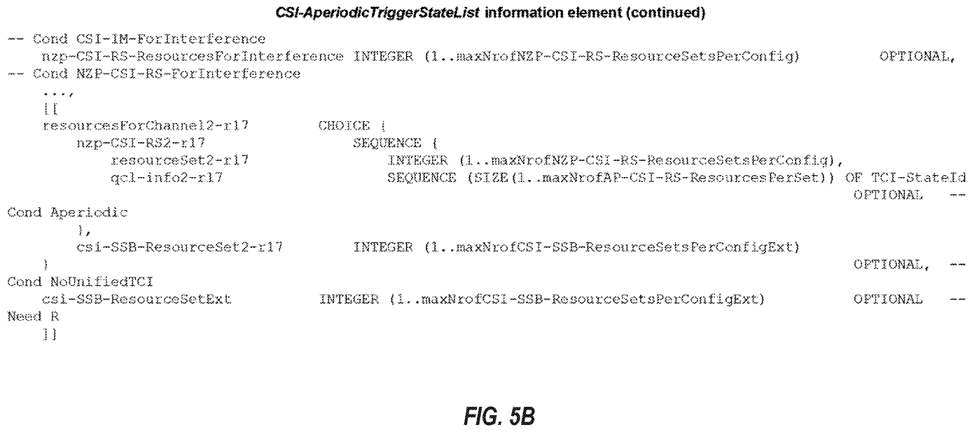

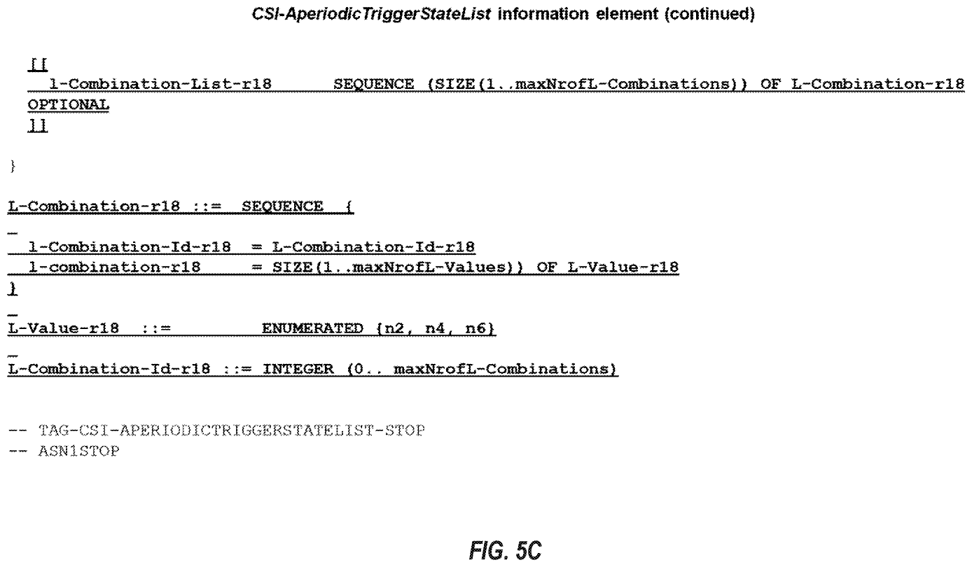

One example of the signaling changes needed to configure the parameter combination list in the CSI-AperiodicTriggerStateList IE are highlighted (via bold, underlined text) in FIGS. 5A-5C. In other words, FIGS. 5A-5C illustrate an example embodiment showing configuration of parameter combination list for aperiodically triggered Type II CSI (changes for configuring the N_{L} parameter combinations or hypotheses are highlighted via bold, underlined text). In the example embodiment of FIGS. 5A-5C, a parameter combination list consisting of N_{L} combinations or hypotheses (i.e., N_{L} is indicated by “maxNrofL-Combinations”, where “maxNrofL-Combinations” can be reported by the UE as part of the UE capability report) is configured as part of CSI-AssociatedReportConfigInfo. Each combination consists of maxNrofL-Values, which is the maximum number of CSI-RS resources for CJT, e.g., maxNrofL-Values=4, “maxNrofL-Values” can also be reported by the UE as part of the UE capability report. Each hypothesis is identified by an identifier (ID), which may be used in the CSI report to identify the UE selected hypothesis.

A network node (e.g., gNB or other Radio Access Network (RAN) node such as, e.g., a RAN node that performs part of the functionality of a base station such as, e.g., a gNB-Central Unit (CU) or gNB-Distributed Unit (DU)) first configures multiple CSI-AssociatedReportConfigInfos to be associated with one CSI report configuration for Type II CJT CSI. Then, the network node may configure one parameter combination list consisting of multiple combinations or hypotheses in each of the multiple CSI-AssociatedReportConfigInfos associated with the one CSI report configuration for Type II CJT CSI. In some embodiments, the number of combinations or hypotheses in the parameter combination list corresponding to each of the multiple CSI-AssociatedReportConfigInfo is the same. In Example 1 below, two different CSI-AssociatedReportConfigInfos associated with the same CSI report config for Type II CJT with two parameter combinations or hypotheses with 3 TRPs (i.e., N_{TRP}=3) is shown:

### Example 1

CSI-AssociatedReportConfigInfo 1:2 combinations/hypotheses {L₁, L₂, L₃}={4, 4, 4} and {L₁, L₂, L₃}={6, 6, 6}
CSI-AssociatedReportConfigInfo 2:2 combinations/hypotheses {L₁, L₂, L₃}={2, 2, 2} and {L₁, L₂, L₃}={2, 4, 4}

In some other embodiments, the number of combinations or hypotheses in the parameter combination lists corresponding to each of the multiple CSI-AssociatedReportConfigInfo is different. In Example 2 below, two different CSI-AssociatedReportConfigInfos associated with the same CSI report config for Type II CJT with two or three parameter combinations or hypotheses with 3 TRPs (i.e., N_{TRP}=3) is shown:

### Example 2

CSI-AssociatedReportConfigInfo 1:2 combinations/hypotheses {L₁, L₂, L₃}={4, 4, 4} and {L₁, L₂, L₃}={6, 6, 6}
CSI-AssociatedReportConfigInfo 2:3 combinations/hypotheses {L₁, L₂, L₃}={2, 2, 2}, {L₁, L₂, L₃}={2, 4, 2}, and {L₁, L₂, L₃}={2, 4, 4}

In the above embodiments, each of the multiple CSI-AssociatedReportConfigInfo can be configured as part of different CSI-AperiodicTriggerStates. Since the different CSI-AperiodicTriggerStates are mapped to different codepoints of the CSI request field in Downlink Control Information (DCI), the network node (e.g., gNB) can flexibly trigger one of the parameter combination lists by triggering the corresponding CSI-AperiodicTriggerState via DCI. The advantage of this embodiment is that the network node (e.g., gNB) can trigger the appropriate parameter combination list once it gets information of the appropriate parameter combination list to be triggered. Considering example 1 above, the first time the network node (e.g., gNB) triggers aperiodic Type II CSI for CJT, it can trigger CSI-AssociatedReportConfigInfo 1. For this first CSI report, let's assume the UE chooses the first combination/hypothesis {L₁, L₂, L₃}={4, 4, 4} even though, for example, the appropriate {L₁, L₂, L₃} may be much smaller than 4. From this first CSI report, network node (e.g., gNB) knows which TRPs are selected and how many SD basis vectors corresponding to the selected TRPs that have Non-Zero Coefficients (NZCs) in the first CSI report. The network node (e.g., gNB) can use this information to select the appropriate combination/hypothesis for the next CSI trigger. For instance, if the appropriate combination/hypothesis is {L₁, L₂, L₃}={2, 2, 2}, then the gNB can trigger CSI-AssociatedReportConfigInfo 2 for the next aperiodic CSI trigger.

### Embodiment 2: Configuration of Parameter Combination List for Semi-Persistent Type II CSI

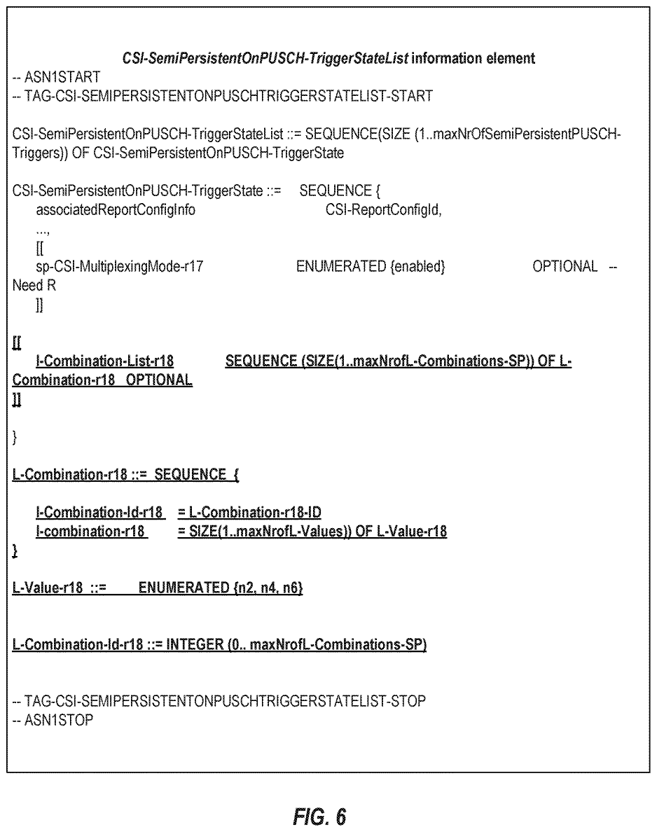

Similarly, for semi-persistent CJT CSI report on PUSCH triggered/activated by DCI format 0_1 or DCI format 0_2, one or more hypotheses or combinations of {Lₙ, n=1, . . . , N_{TRP}} may be configured in the corresponding CSI-SemiPersistentOnPUSCH-TriggerState associated to a CJT CSI report configuration. An example is shown below in FIG. 6. In other words, FIG. 6 illustrates an example embodiment showing configuration of parameter combination list for semi-persistently triggered Type II CSI (changes for configuring the N_{L} parameter combinations or hypotheses are highlighted via bold, underlined text). Note that the CSI-SemiPersistentOnPUSCH-TriggerStateList IE is as defined in 3GPP TS 38.331 (see, e.g., V17.2.0), and changes needed to configure the parameter combination list in the CSI-SemiPersistentOnPUSCH-TriggerStateList IE are highlighted via bold, underlined text in FIG. 6.

In the example embodiment of FIG. 6, a parameter combination list consisting of N_{L} combinations or hypotheses (i.e., N_{L} is indicated by “maxNrofL-Combinations-SP”, where “maxNrofL-Combinations-SP” can be reported by the UE as part of the UE capability report) is configured as part of CSI-SemiPersistentOnPUSCH-TriggerState. Each combination consists of maxNrofL-Values, which is the maximum number of CSI-RS resources for CJT, e.g., maxNrofL-Values=4, “maxNrofL-Values” can also be reported by the UE as part of the UE capability report. Each hypothesis is identified by an identifier (ID), which may be used in the CSI report to identify the UE selected hypothesis.

This embodiment allows different combinations or hypotheses to be configured to different CSI-SemiPersistentOnPUSCH-TriggerState's that are associated with the same Type II CJT report configuration. The network has the flexibility to activate different combinations or hypotheses by triggering different semi-persistent CSI trigger states when activating the semi-persistent type II CSI report on PUSCH.

### Embodiment 3: Configuration of Parameter Combinations as Part of CodebookConfig

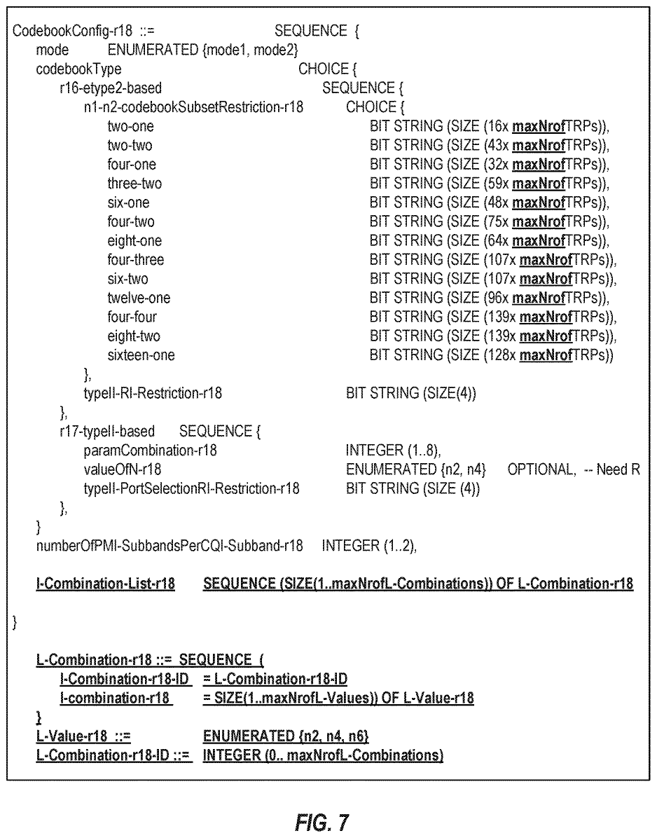

In an alternative embodiment, one or more hypotheses or combinations of {Lₙ, n=1, . . . , N_{TRP}} may be configured in the corresponding codebook configuration (i.e., the CodebookConfig IE) within a CJT CSI report configuration. An example is shown below in FIG. 7. Note that the CodebookConfig IE is as defined in 3GPP TS 38.331 V17.2.0, and changes needed to configure the parameter combination list in the CodebookConfig IE are highlighted via bold, underlined text in FIG. 7. FIG. 7 illustrates an example embodiment showing configuration of parameter combination list as part of codebook configuration where changes for configuring the N_{L} parameter combinations or hypotheses are highlighted via bold, underlined text.

In the example embodiment of FIG. 7, a parameter combination list consisting of N_{L} combinations or hypotheses (i.e., N_{L} is indicated by “maxNrofL-Combinations”, where “maxNrofL-Combinations” can be reported by the UE as part of the UE capability report) is configured as part of CodebookConfig. Each combination consists of maxNrofL-Values, which is the maximum number of CSI-RS resources for CJT, e.g., maxNrofL-Values=4, “maxNrofL-Values” can also be reported by the UE as part of the UE capability report. Each hypothesis is identified by an identifier (ID), which may be used in the CSI report to identify the UE selected hypothesis.

Note that in some embodiments, the configuration of the parameter combination list consisting of N_{L} combinations or hypotheses is conditioned on codebookType parameter being configured to a Type II codebook with support for CJT (i.e., with support for spatial beams being selected from multiple CSI-RS resources configured for CJT). That is, the parameter combination list is only configured in CodebookConfig if the codebookType is Type II.

### Embodiment 4: Configuring Beam Combination Hypothesis Together with Other Parameters

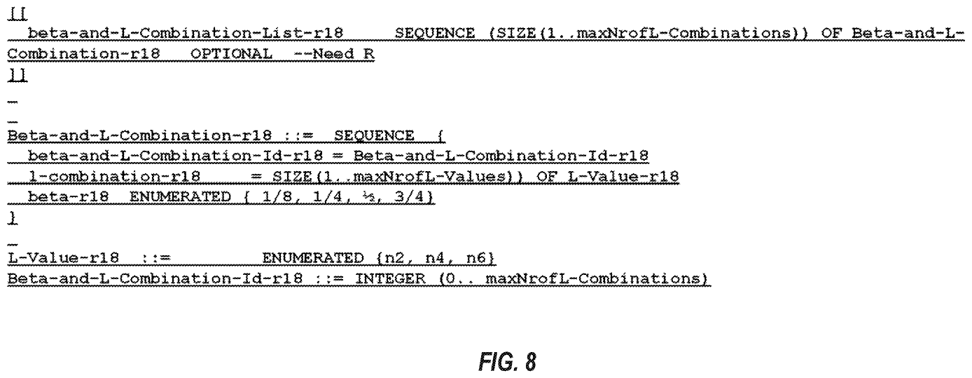

In another embodiment, parameter β may be configured together with each {Lₙ, n=1, . . . , N_{TRP}} hypothesis. An example of configuring Lₙ combinations together with β is shown in FIG. 8. Note that this embodiment can be combined with any of the embodiments shown in FIGS. 5A-5C, FIG. 6, or FIG. 7. That is, the combined configuration of beta parameter as part of the N_{L} parameter configuration can be configured as part of the CSI-AperiodicTriggerStateList IE, the CSI-SemiPersistentOnPUSCH-TriggerStateList IE, or the CodebookConfig IE.

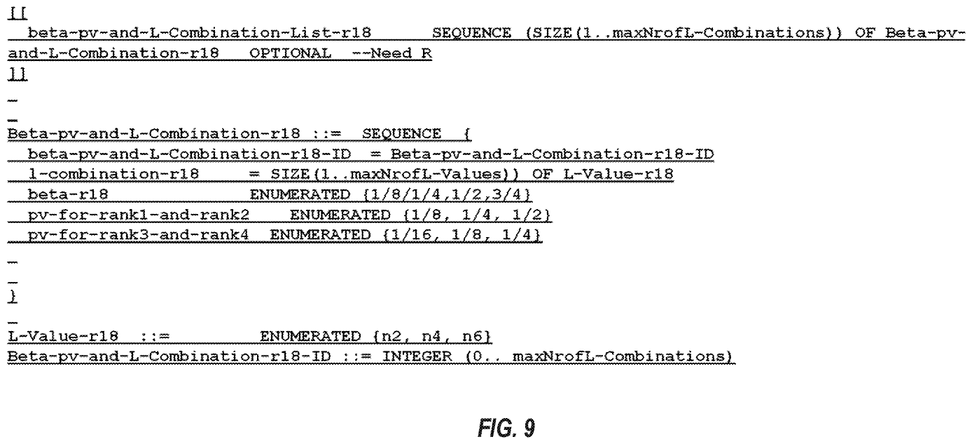

In a further embodiment, both parameters β and pᵥ may be configured together with each {Lₙ, n=1, . . . , N_{TRP}} hypothesis as shown in FIG. 9, where pᵥ for ranks 1 and 2 may be configured differently than pᵥ for ranks 3 and 4. Note that this embodiment can be combined with any of the embodiments shown in FIGS. 5A-5C, FIG. 6, or FIG. 7. That is, the combined configuration of beta parameter as part of the N_{L} parameter configuration can be configured as part of the CSI-AperiodicTriggerStateList IE, the CSI-SemiPersistentOnPUSCH-TriggerStateList IE, or the CodebookConfig IE.

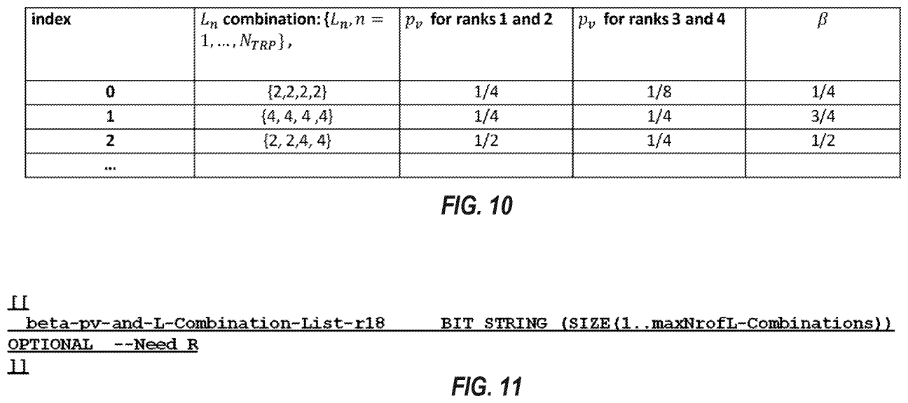

In yet another embodiment, {Lₙ, n=1, . . . , N_{TRP}} combination hypotheses together with β and pᵥ may be prespecified in a table where each row of the table corresponding to one {Lₙ} combination hypothesis together with associated β and pᵥ values as shown by an example in FIG. 10. One or more of the rows may be configured by the gNB for a CJT CSI report. Such configuration may for example by configuring a subset (or the full set) of the rows of the pre-specified table via a binary bitmap.

If more than one rows are configured, it corresponds to multiple hypotheses and the UE would select one of the hypotheses and report CJT CSI according to the selected hypothesis.

If the pre-specified table has Ny rows, then a bit string of length Ny may be configured to the UE wherein the n^{th} (n=1, . . . , N_{L}) bit in the bitstring (as shown in FIG. 11) can be used to indicate whether the n^{th} row in the prespecified table is selected or not. FIG. 11 illustrates an example of configuring a bit string to select a subset or a whole set of the prespecified parameter combination table. Note that this embodiment can be combined with any of the embodiments shown in FIGS. 5A-5C, FIG. 6, or FIG. 7. That is, the bit string can be configured as part of the CSI-AperiodicTriggerStateList IE, the CSI-SemiPersistentOnPUSCH-TriggerStateList IE, or the CodebookConfig IE in order to select a subset or the whole set of rows of the prespecified table.

In some scenarios, a UE may not support more than one hypothesis and in that case, only one hypothesis would be configured. In a general scenario, a UE may indicate the maximum number of supported hypotheses in a capability signaling and the number of configured hypotheses shall not exceed the UE reported capability. In some scenarios, a default maximum number of hypotheses may be specified in which when a UE does not indicate the maximum number of supported hypotheses, the default number is assumed by the gNB.

### Embodiment 5: Other Alternative Embodiments

In legacy R16 type II CSI feedback, L, pᵥ and β are jointly configured. B is used to control the Non-zero coefficients as a percentage of the total coefficients and perhaps can be configured separately. pᵥ is used to control the number of FD vectors, which depending on delay spread and should be independent of the number of spatial beams.

In this embodiment, the hypotheses for {Lₙ} and the pᵥ hypotheses and β are configured separately. In below, examples are given on how the parameters may be configured in different IEs (CSI-AperiodicTriggerStateList, CSI-AperiodicTriggerState, CSI-AssociatedReportConfigInfo, CSI-ReportConfig or CodebookConfig). Additionally, different combinations may be applied:
First option: each of the {Lₙ} hypothesis, β and pᵥ parameters are configured separately.
Second option: the {Lₙ} hypothesis is configured separately from β and pᵥ parameter combination.
Third option: the {Lₙ} hypothesis is configured together with β and pᵥ parameter is configured separately and so on.

In case the UE is configured with more than one hypotheses for any of {Lₙ}, β, pᵥ, or any combination of these parameters, then the UE needs to select one of the hypotheses and indicate the selection to the network in the Type II CJT CSI report. Depending on whether {Lₙ}, β, and pᵥ are configured jointly or separately, one or more indices may need to be reported by the UE to indicate the selection.

In one example, according to the above description, the hypothesis of {Lₙ} are configured in an aperiodic trigger state; and the pᵥ and β parameters are configured in the CSI-AssociatedReportConfigInfo. In this way, for one aperiodic trigger state, UE has one or more hypothesis which is associated with up to 16 combinations of pᵥ and β. ASN1 code for this embodiment is given as below

CSI-AperiodicTriggerStateList information element

-- ASN1START
-- TAG-CSI-APERIODICTRIGGERSTATELIST-START
CSI-AperiodicTriggerStateList ::= SEQUENCE (SIZE (1..maxNrOfCSI-AperiodicTriggers))
OF CSI-AperiodicTriggerState

| | |
|---|---|
| CSI-AperiodicTriggerState ::= | SEQUENCE { |
| associatedReportConfigInfoList | SEQUENCE |

```
(SIZE(1..maxNrofReportConfigPerAperiodicTrigger)) OF CSI-AssociatedReportConfigInfo,
  ...,
  [[
```

| | |
|---|---|
| ap-CSI-MultiplexingMode-r17 | ENUMERATED {enabled} |

```
OPTIONAL -- Need R
  ]],
  [[
```

| | |
|---|---|
| l-Combination-List-r18 | SEQUENCE (SIZE(1..maxNrofL-Combinations)) OF L- |
| Combination-r18 | OPTIONAL -- Need R |

]]
}
CSI-AssociatedReportConfigInfo ::= SEQUENCE {

| | |
|---|---|
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS-ResourcesPerSet)) |

OF TCI-StateId

OPTIONAL -- Cond Aperiodic

},

| | |
|---|---|
| csi-SSB-ResourceSet | INTEGER (1..maxNrofCSI-SSB-ResourceSetsPerConfig) |

},

| | |
|---|---|
| csi-IM-ResourcesForInterference | INTEGER(1..maxNrofCSI-IM-ResourceSetsPerConfig) |

OPTIONAL, -- Cond CSI-IM-ForInterference
nzp-CSI-RS-ResourcesForInterference INTEGER (1..maxNrofNZP-CSI-RS-

| | |
|---|---|
| ResourceSetsPerConfig) | OPTIONAL, -- Cond NZP-CSI-RS-ForInterference |

```
  ...,
  [[
```

| | |
|---|---|
| resourcesForChannel2-r17 | CHOICE { |
| nzp-CSI-RS2-r17 | SEQUENCE { |
| resourceSet2-r17 | INTEGER (1..maxNrofNZP-CSI-RS-ResourceSetsPerConfig), |
| qcl-info2-r17 | SEQUENCE (SIZE(1..maxNrofAP-CSI-RS-ResourcesPerSet)) |

OF TCI-StateId

OPTIONAL -- Cond Aperiodic

},

| | |
|---|---|
| csi-SSB-ResourceSet2-r17 | INTEGER (1..maxNrofCSI-SSB- |

ResourceSetsPerConfigExt)

| | |
|---|---|
| } | OPTIONAL, -- Cond |

NoUnifiedTCI

| | |
|---|---|
| csi-SSB-ResourceSetExt | INTEGER (1..maxNrofCSI-SSB-ResourceSetsPerConfigExt) |

```
OPTIONAL -- Need R
  ]] ,
  [[
```

| | |
|---|---|
| Beta-pv-Combination-r18 | SetupRelease { Beta-pv-Combination-r18 } |

```
OPTIONAL -- Need M
  ]]
}
      L-Combination-r18 ::= SEQUENCE (
        l-Combination-Id-r18 = L-Combination-Id-r18
```

| | |
|---|---|
| l-combination-r18 | = SIZE(1..maxNrofL-Values)) OF L-Value-r18 |

}

| | |
|---|---|
| L-Value-r18 ::= | ENUMERATED {n2, n4, n6} |

L-Combination-Id-r18 ::= INTEGER (0.. maxNrofL-Combinations)
Beta-pv-Combination-r18 ::= SEQUENCE (

| | |
|---|---|
| beta-r18 | ENUMERATED |

{⅛/¼,½,¾}

| | |
|---|---|
| pv-for-rank1-and-rank2-r18 | ENUMERATED {⅛, ¼, ½} |
| pv-for-rank3-and-rank4-r18 | ENUMERATED { 1/16, ⅛, ¼} |

}
-- TAG-CSI-APERIODICTRIGGERSTATELIST-STOP
-- ASN1STOP

In another embodiment, the pᵥ and β values are configured in an Aperiodic trigger state and the hypothesis of {Lₙ} is configured in the CSI-AssociatedReportConfigInfo. In this way, for one Aperiodic trigger state UE has certain β and pᵥ configuration and each CSI-AssociatedReportConfigInfo which also configures the channel and interference resource hypothesis, includes the hypothesis of {Lₙ}. ASN1 code for this embodiment is given as below

CSI-AperiodicTriggerStateList information element

-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI-AperiodicTriggers)) |

OF CSI-AperiodicTriggerState

| | |
|---|---|
| CSI-AperiodicTriggerState ::= | SEQUENCE { |
| associatedReportConfigInfoList | SEQUENCE |

```
(SIZE(1..maxNrofReportConfigPerAperiodicTrigger)) OF CSI-AssociatedReportConfigInfo,
  ...,
  [[
```

| | |
|---|---|
| ap-CSI-MultiplexingMode-r17 | ENUMERATED {enabled} |

```
OPTIONAL -- Need R
  ]] ,
  [[
```

| | |
|---|---|
| Beta-pv-Combination-r18 | SetupRelease { Beta-pv-Combination-r18 } |

OPTIONAL -- Need M
]]
}
CSI-AssociatedReportConfigInfo ::= SEQUENCE {

| | |
|---|---|
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS-ResourcesPerSet)) |

OF TCI-StateId

OPTIONAL -- Cond Aperiodic

},

| | |
|---|---|
| csi-SSB-ResourceSet | INTEGER (1..maxNrofCSI-SSB-ResourceSetsPerConfig) |
| }, | |
| csi-IM-ResourcesForInterference | INTEGER(1..maxNrofCSI-IM-ResourceSetsPerConfig) |

OPTIONAL, -- Cond CSI-IM-ForInterference
nzp-CSI-RS-ResourcesForInterference INTEGER (1..maxNrofNZP-CSI-RS-

| | |
|---|---|
| ResourceSetsPerConfig) | OPTIONAL, -- Cond NZP-CSI-RS-ForInterference |

```
  ...,
  [[
```

| | |
|---|---|
| resourcesForChannel2-r17 | CHOICE { |
| nzp-CSI-RS2-r17 | SEQUENCE { |
| resourceSet2-r17 | INTEGER (1..maxNrofNZP-CSI-RS-ResourceSetsPerConfig), |
| qcl-info2-r17 | SEQUENCE (SIZE(1..maxNrofAP-CSI-RS-ResourcesPerSet)) |

OF TCI-StateId

OPTIONAL -- Cond Aperiodic

},

| | |
|---|---|
| csi-SSB-ResourceSet2-r17 | INTEGER (1..maxNrofCSI-SSB- |

ResourceSetsPerConfigExt)

| | |
|---|---|
| } | OPTIONAL, -- Cond |

NoUnifiedTCI

| | |
|---|---|
| csi-SSB-ResourceSetExt | INTEGER (1..maxNrofCSI-SSB-ResourceSetsPerConfigExt) |

```
OPTIONAL -- Need R
  ]],
  [[
```

| | |
|---|---|
| l-Combination-List-r18 | SEQUENCE (SIZE(1..maxNrofL-Combinations)) OF L- |
| Combination-r18 | OPTIONAL -- Need R |

```
  ]]
}
L-Combination-r18 ::= SEQUENCE (
        l-Combination-Id-r18 = L-Combination-Id-r18
```

| | |
|---|---|
| l-combination-r18 | = SIZE(1..maxNrofL-Values)) OF L-Value-r18 |

}

| | |
|---|---|
| L-Value-r18 ::= | ENUMERATED {n2, n4, n6} |

L-Combination-Id-r18 ::= INTEGER (0.. maxNrofL-Combinations)
Beta-pv-Combination-r18 ::= SEQUENCE (

| | |
|---|---|
| beta-r18 | ENUMERATED |

{⅛/¼,½,¾}

| | |
|---|---|
| pv-for-rank1-and-rank2-r18 | ENUMERATED {⅛, ¼, ½} |
| pv-for-rank3-and-rank4-r18 | ENUMERATED { 1/16, ⅛, ¼} |

}
-- TAG-CSI-APERIODICTRIGGERSTATELIST-STOP
-- ASN1STOP

In a yet another embodiment, the {Lₙ} hypothesis are configured either in the aperiodic trigger state or in the aperiodic trigger state info, but the β and pᵥ parameters are configured in CSI-reportconfig or in the codebookConfig, which is a field of the CSI-reportconfig.

In a yet another embodiment, the beta and pᵥ parameters are configured either in the aperiodic trigger state or in the aperiodic trigger state info, but the {Lₙ} hypothesis are configured in CSI-reportconfig or in the codebookConfig, which is a field of the CSI-reportconfig.

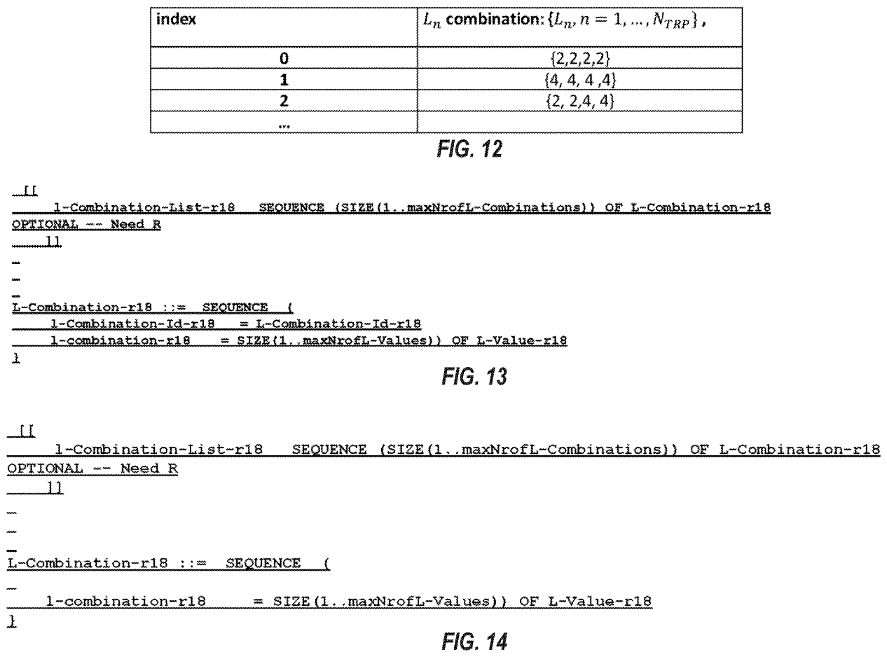

In a variant of these embodiments, a table is specified for the possible {Lₙ} hypothesis as shown in FIG. 12 and index of a row in this table is configured instead of L-Value-r18::=ENUMERATED {n2, n4, n6}. This option is applicable to all sub embodiments under “embodiment 5”.

In all of the examples given above, UE may be given more than one β or pᵥ parameters. In this case, an ID is needed for each value/combination, or each joint configuration such that UE may indicate the ID back to the gNB in the CSI report. An example of explicit ID is given in FIG. 13.

Alternatively, the ID may be implicit (in which case, it does not need to be configured explicitly). In this case, the j^{th} ID is implicitly assumed for the j^{th} parameter or parameter combination (i.e., the ID is implicitly allocated in the order in which the value or parameter combination is in the list configured for the UE). An example of implicit ID is given in FIG. 14.

### Further Description

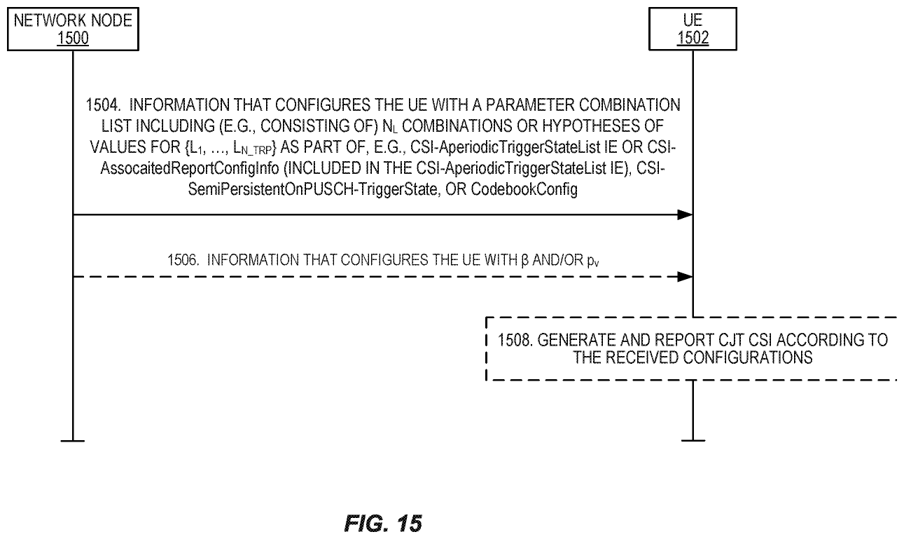

FIG. 15 illustrates the operation of a network node 1500 and a UE 1502 to support extension of (e.g., NR Release 16) type II codebook to CJT in accordance with at least some of the embodiments described above. Optional steps are represented by dashed lines/boxes. The network node 1500 may be, for example, a base station (e.g., a gNB) or some other Radio Access Network (RAN) node such as, e.g., a RAN node that performs part of the functionality of a base station (e.g., a gNB-Central Unit (CU) or gNB-Distributed Unit (DU)).

As illustrated, the network node 1500 sends, to the UE 1502, information that configures the UE 1502 with a parameter combination list including (e.g., consisting of) N_{L} combinations or hypotheses of values for {L₁, . . . , L_{N}_{_{TRP}}} as part of, e.g., CSI-AperiodicTriggerStateList IE or CSI-AssocaitedReportConfigInfo (included in the CSI-AperiodicTriggerStateList IE), CSI-SemiPersistentOnPUSCH-TriggerState, or CodebookConfig, as described above (step 1504). N_{L} is the number of hypotheses in the list. Taking FIGS. 5A-5C, for example, this N_{L} would be the size of l-Combination-List-r18. Letting Lₙ be the number of SD basis vectors to be selected from CSI-RS resource n, the number of SD basis vectors to be selected across all the CSI-RS resources is then given by {L₁, . . . , L_{N}_{_{TRP}}}. The parameter combination list configured in step 1504 includes (e.g., consists of) N_{L} combinations or hypotheses of values for {L₁, . . . , L_{N}_{_{TRP}}}. In one embodiment, a parameter β may be configured together with each {Lₙ, n=1, . . . , N_{TRP}} hypothesis, as described above. In another embodiment, both parameters β and pᵥ may be configured together with each {Lₙ, n=1, . . . , N_{TRP}} hypothesis, as described above. In one embodiment, the information sent in step 1504 includes the parameter combination list and optionally the parameter β and further optionally the parameter pᵥ. In another embodiment, the information sent in step 1504 includes an index to a predefined or configured table where the index maps to a row of the table that includes the parameter combination list and optionally the parameter (and further optionally the parameter pᵥ, as described above.

In one embodiment, the parameter combination list is sent as part of CSI-AperiodicTriggerStateList IE. Further, in one embodiment, the number of combinations or hypotheses in the parameter combination list corresponding to each of multiple CSI-AssociatedReportConfigInfos included in the CSI-AperiodicTriggerStateList IE is the same. In another embodiment, the number of combinations or hypotheses in the parameter combination list corresponding to each of multiple CSI-AssociatedReportConfigInfos included in the CSI-AperiodicTriggerStateList IE can be different. In one embodiment, each of the multiple CSI-AssociatedReportConfigInfo can be configured as part of different CSI-AperiodicTriggerStates included in the CSI-AperiodicTriggerStateList IE.

In one embodiment, for semi-persistent CJT CSI report on PUSCH triggered/activated by DCI format 0_1 or DCI format 0_2, one or more hypotheses or combinations of {Lₙ, n=1, . . . , N_{TRP}} may be configured in the corresponding CSI-SemiPersistentOnPUSCH-TriggerState associated to a CJT CSI report configuration. In one embodiment, the parameter combination list including (e.g., consisting of) of N_{L} combinations or hypotheses is configured as part of the CSI-SemiPersistentOnPUSCH-TriggerState, as described above.

In one embodiment, the one or more hypotheses or combinations of {Lₙ, n=1, . . . , N_{TRP}} may be configured in the corresponding codebook configuration (i.e., the CodebookConfig IE) within a CJT CSI report configuration, as described above.

Optionally, the network node 1500 sends, to the UE 1502, information that configures the UE 1502 with pᵥ hypotheses and β separately from the parameter combination list, as described above (step 1506).

The UE 1502 then generates and reports CJT CSI in accordance with the configuration of step 1504 and optionally step 1506 (step 1508).

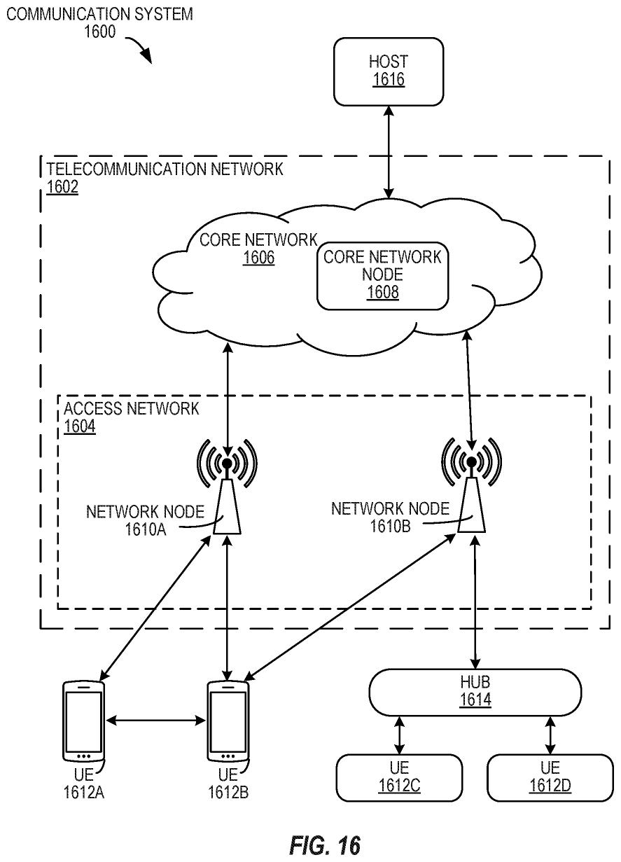

FIG. 16 shows an example of a communication system 1600 in accordance with some embodiments.

In the example, the communication system 1600 includes a telecommunication network 1602 that includes an access network 1604, such as a Radio Access Network (RAN), and a core network 1606, which includes one or more core network nodes 1608. The access network 1604 includes one or more access network nodes, such as network nodes 1610A and 1610B (one or more of which may be generally referred to as network nodes 1610), or any other similar Third Generation Partnership Project (3GPP) access node or non-3GPP Access Point (AP). The network nodes 1610 facilitate direct or indirect connection of User Equipment (UE), such as by connecting UEs 1612A, 1612B, 1612C, and 1612D (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system 1600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1602 is a cellular network that implements 3GPP standardized features. Accordingly, the telecommunication network 1602 may support network slicing to provide different logical networks to different devices that are connected to the telecommunication network 1602. For example, the telecommunication network 1602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1614 communicates with the access network 1604 to facilitate indirect communication between one or more UEs (e.g., UE 1612C and/or 1612D) and network nodes (e.g., network node 1610B). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a Virtual Reality (VR) headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610B. The hub 1614 may also allow for a different communication scheme and/or schedule between the hub 1614 and UEs (e.g., UE 1612C and/or 1612D), and between the hub 1614 and the core network 1606. In other examples, the hub 1614 is connected to the core network 1606 and/or one or more UEs via a wired connection. Moreover, the hub 1614 may be configured to connect to a Machine-to-Machine (M2M) service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610B. In other embodiments, the hub 1614 may be a non-dedicated hub—that is, a device which is capable of operating to route communications between the UEs and the network node 1610B, but which is additionally capable of operating as a communication start and/or end point for certain data channels.

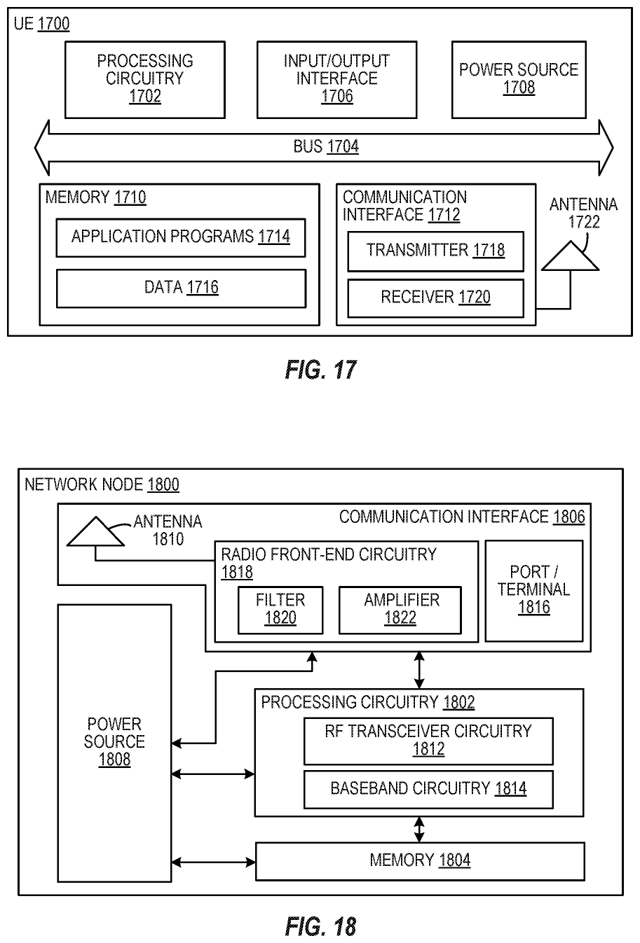

FIG. 17 shows a UE 1700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1702 may include multiple Central Processing Units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging the power source 1708. Power circuitry may perform any formatting, converting, or other modification to the power from the power source 1708 to make the power suitable for the respective components of the UE 1700 to which power is supplied.

The memory 1710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1710 may allow the UE 1700 to access instructions, application programs, and the like stored on transitory or non-transitory memory media, to off-load data, or to upload data. An article of manufacture, such as one utilizing a communication system, may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., the antenna 1722) and may share circuit components, software, or firmware, or alternatively be implemented separately.

In the illustrated embodiment, communication functions of the communication interface 1712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 18 shows a network node 1800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP)

5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes processing circuitry 1802, memory 1804, a communication interface 1806, and a power source 1808. The network node 1800 may be composed of multiple physically separate components (e.g., a Node B component and an RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1800 may be configured to support multiple RATs. In such embodiments, some components may be duplicated (e.g., separate memory 1804 for different RATs) and some components may be reused (e.g., an antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1800.

The processing circuitry 1802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1800 components, such as the memory 1804, to provide network node 1800 functionality.

In some embodiments, the processing circuitry 1802 includes a System on a Chip (SOC). In some embodiments, the processing circuitry 1802 includes one or more of Radio Frequency (RF) transceiver circuitry 1812 and baseband processing circuitry 1814. In some embodiments, the RF transceiver circuitry 1812 and the baseband processing circuitry 1814 may be on separate chips (or sets of chips), boards, or units, such as radio units and digital units. In alternative embodiments, part or all of the RF transceiver circuitry 1812 and the baseband processing circuitry 1814 may be on the same chip or set of chips, boards, or units.

The memory 1804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and the memory 1804 are integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. The radio front-end circuitry 1818 comprises filters 1820 and amplifiers 1822. The radio front-end circuitry 1818 may be connected to the antenna 1810 and the processing circuitry 1802. The radio front-end circuitry 1818 may be configured to condition signals communicated between the antenna 1810 and the processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of the filters 1820 and/or the amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface 1806 may comprise different components and/or different combinations of components.

In certain alternative embodiments, the network node 1800 does not include separate radio front-end circuitry 1818; instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes the one or more ports or terminals 1816, the radio front-end circuitry 1818, and the RF transceiver circuitry 1812 as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, the communication interface 1806, and/or the processing circuitry 1802 may be configured to perform any receiving operations and/or certain obtaining operations described herein as being performed by the network node 1800. Any information, data, and/or signals may be received from a UE, another network node, and/or any other network equipment. Similarly, the antenna 1810, the communication interface 1806, and/or the processing circuitry 1802 may be configured to perform any transmitting operations described herein as being performed by the network node 1800. Any information, data, and/or signals may be transmitted to a UE, another network node, and/or any other network equipment.

The power source 1808 provides power to the various components of the network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid or an electricity outlet) via input circuitry or an interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

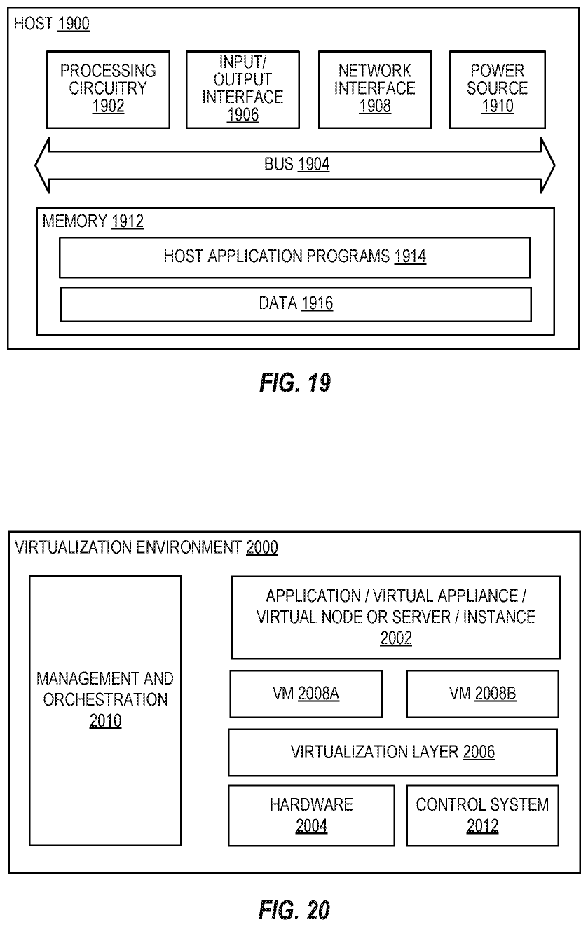

FIG. 19 is a block diagram of a host 1900, which may be an embodiment of the host 1616 of FIG. 16, in accordance with various aspects described herein. As used herein, the host 1900 may be or comprise various combinations of hardware and/or software including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and memory 1912. Other components may be included in other embodiments. Features of these components may be substantially similar to those described with respect to the devices of previous figures, such as FIGS. 17 and 18, such that the descriptions thereof are generally applicable to the corresponding components of the host 1900.

The memory 1912 may include one or more computer programs including one or more host application programs 1914 and data 1916, which may include user data, e.g. data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for Over-The-Top (OTT) services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment 2000 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or VM Monitors (VMMs)), provide VMs 2008A and 2008B (one or more of which may be generally referred to as VMs 2008), and/or perform any of the functions, features, and/or benefits described in relation with some embodiments described herein. The virtualization layer 2006 may present a virtual operating platform that appears like networking hardware to the VMs 2008.

The VMs 2008 comprise virtual processing, virtual memory, virtual networking, or interface and virtual storage, and may be run by a corresponding virtualization layer 2006. Different embodiments of the instance of a virtual appliance 2002 may be implemented on one or more of the VMs 2008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2008 may be a software implementation of a physical machine that runs programs as if they were executing on a physical, non-virtualized machine. Each of the VMs 2008, and that part of the hardware 2004 that executes that VM, be it hardware dedicated to that VM and/or hardware shared by that VM with others of the VMs 2008, forms separate virtual network elements. Still in the context of NFV, a virtual network function is responsible for handling specific network functions that run in one or more VMs 2008 on top of the hardware 2004 and corresponds to the application 2002.

The hardware 2004 may be implemented in a standalone network node with generic or specific components. The hardware 2004 may implement some functions via virtualization. Alternatively, the hardware 2004 may be part of a larger cluster of hardware (e.g., such as in a data center or CPE) where many hardware nodes work together and are managed via management and orchestration 2010, which, among others, oversees lifecycle management of the applications 2002. In some embodiments, the hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 2012 which may alternatively be used for communication between hardware nodes and radio units.

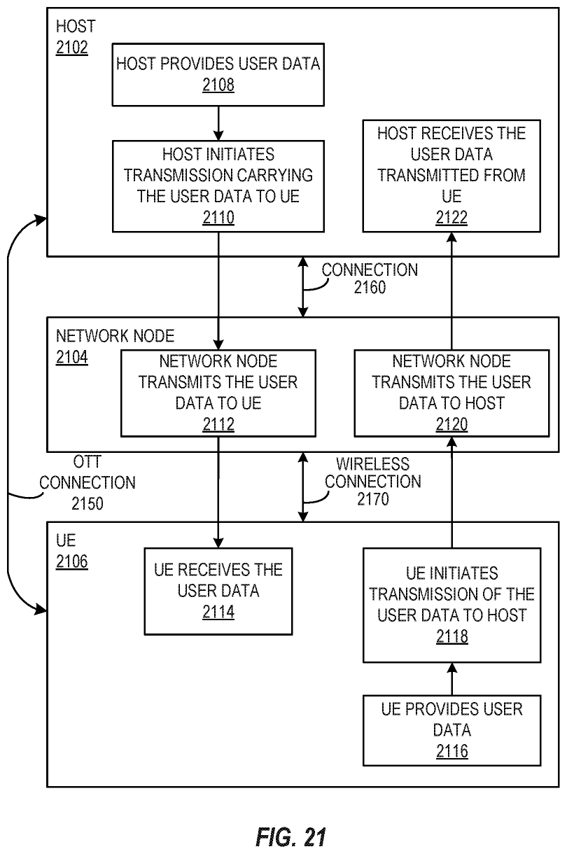

FIG. 21 shows a communication diagram of a host 2102 communicating via a network node 2104 with a UE 2106 over a partially wireless connection in accordance with some embodiments. Example implementations, in accordance with various embodiments, of the UE (such as the UE 1612A of FIG. 16 and/or the UE 1700 of FIG. 17), the network node (such as the network node 1610A of FIG. 16 and/or the network node 1800 of FIG. 18), and the host (such as the host 1616 of FIG. 16 and/or the host 1900 of FIG. 19) discussed in the preceding paragraphs will now be described with reference to FIG. 21.

Like the host 1900, embodiments of the host 2102 include hardware, such as a communication interface, processing circuitry, and memory. The host 2102 also includes software, which is stored in or is accessible by the host 2102 and executable by the processing circuitry. The software includes a host application that may be operable to provide a service to a remote user, such as the UE 2106 connecting via an OTT connection 2150 extending between the UE 2106 and the host 2102. In providing the service to the remote user, a host application may provide user data which is transmitted using the OTT connection 2150.

The network node 2104 includes hardware enabling it to communicate with the host 2102 and the UE 2106 via a connection 2160. The connection 2160 may be direct or pass through a core network (like the core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by the UE 2106 and executable by the UE's processing circuitry. The software includes a client application, such as a web browser or operator-specific “app” that may be operable to provide a service to a human or non-human user via the UE 2106 with the support of the host 2102. In the host 2102, an executing host application may communicate with the executing client application via the OTT connection 2150 terminating at the UE 2106 and the host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via the connection 2160 between the host 2102 and the network node 2104 and via a wireless connection 2170 between the network node 2104 and the UE 2106 to provide the connection between the host 2102 and the UE 2106. The connection 2160 and the wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104 in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR, or AR which it can broadcast, multicast, or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 2150 between the host 2102 and the UE 2106 in response to variations in the measurement results. The measurement procedure and/or the network functionality for reconfiguring the OTT connection 2150 may be implemented in software and hardware of the host 2102 and/or the UE 2106. In some embodiments, sensors (not shown) may be deployed in or in association with other devices through which the OTT connection 2150 passes; the sensors may participate in the measurement procedure by supplying values of the monitored quantities exemplified above, or by supplying values of other physical quantities from which software may compute or estimate the monitored quantities. The reconfiguring of the OTT connection 2150 may include message format, retransmission settings, preferred routing, etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency, and the like by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally. Some example embodiments of the present disclosure are as follows:

### Group A Embodiments

Embodiment 1: A method performed by a User Equipment, UE, (1502), the method comprising: receiving (1504), from a network node (1500), information that configures the UE (1502) with a parameter combination list including (e.g., consisting of) N_{L} combinations or hypotheses of values for {L₁, . . . , L_{N}_{_{TRP}}} as part of, e.g., CSI-AperiodicTriggerStateList IE or CSI-AssocaitedReportConfigInfo (included in the CSI-AperiodicTriggerStateList IE), CSI-SemiPersistentOnPUSCH-TriggerState, or CodebookConfig; and generating and reporting (1508) Coherent Joint Transmission, CJT, Channel State Information, CSI, in accordance with the received information.
Embodiment 2: The method of embodiment 1 wherein Lₙ is a number of Spatial Domain, SD, basis vectors to be selected from CSI Reference Signal, CSI-RS, resource n, and the number of SD basis vectors to be selected across all the CSI-RS resources is given by {L₁, . . . , L_{N}_{_{TRP}}}, where N_{TRP} is the number of Transmission/Reception Points, TRPs.
Embodiment 3: The method of embodiment 1 or 2 wherein a parameter β is configured together with each {Lₙ, n=1, . . . , N_{TRP}} hypothesis.
Embodiment 4: The method of embodiment 1 or 2 wherein both parameters β and pᵥ are configured together with each {Lₙ, n=1, . . . , N_{TRP}} hypothesis.
Embodiment 5: The method of embodiment 1 or 2 further comprising receiving (1506), from the network node (1500), information that configures the UE (1502) with parameter β and/or parameter pᵥ, separately from the information that configures the UE (1502) with the parameter combination list.
Embodiment 6: The method of any of embodiments 1 to 5 wherein the information that configures the UE (1502) with the parameter combination list comprises the parameter combination list.
Embodiment 7: The method of any of embodiments 1 to 5 wherein the information that configures the UE (1502) with the parameter combination list comprises an index or value that is mapped to the parameter combination list (e.g., via a predefined or configured table).
Embodiment 8: The method of any of embodiments 1 to 7 wherein the information that configures the UE (1502) with the parameter combination list is part of a CSI-AperiodicTriggerStateList IE.
Embodiment 9: The method of embodiment 8 wherein the number of combinations or hypotheses in the parameter combination list corresponding to each of multiple CSI-AssociatedReportConfigInfo's included in the CSI-AperiodicTriggerStateList IE is the same.
Embodiment 10: The method of embodiment 8 wherein the number of combinations or hypotheses in the parameter combination list corresponding to each of multiple CSI-AssociatedReportConfigInfo's included in the CSI-AperiodicTriggerStateList IE is different.
Embodiment 10a: The method of any of 9 or 10 wherein the number of combinations or hypotheses is a UE capability and is reported to the network by the UE.
Embodiment 11: The method of any of embodiments 1 to 7 wherein the information that configures the UE (1502) with the parameter combination list is part of a CSI-SemiPersistentOnPUSCH-TriggerState.
Embodiment 12: The method of any of embodiments 1 to 7 wherein the generated and reported CJT CSI is for semi-persistent CJT CSI report on PUSCH triggered or activated by DCI format 0_1 or DCI format 0_2, and the information that configures the UE (1502) with the parameter combination list is part of a CSI-SemiPersistentOnPUSCH-TriggerState associated to a CJT CSI report configuration.
Embodiment 13: The method of any of embodiments 1 to 7 wherein the information that configures the UE (1502) with the parameter combination list is part of a CodebookConfig IE.
Embodiment 14: The method of any of embodiments 1 to 7 wherein the information that configures the UE (1502) with the parameter combination list is part of a codebook configuration within a CJT CSI report configuration.
Embodiment 15: The method of any of the previous embodiments, further comprising: providing user data; and forwarding the user data to a host via the transmission to the network node.

### Group B Embodiments

Embodiment 16: A method performed by a network node (1500), the method comprising: sending (1504), to a User Equipment, UE, (1502), information that configures the UE (1502) with a parameter combination list including (e.g., consisting of) Nz combinations or hypotheses of values for {L₁, . . . , L_{N}_{_{TRP}}} as part of, e.g., CSI-AperiodicTriggerStateList IE or CSI-AssocaitedReportConfigInfo (included in the CSI-AperiodicTriggerStateList IE), CSI-SemiPersistentOnPUSCH-TriggerState, or CodebookConfig.
Embodiment 17: The method of embodiment 16 wherein Lₙ is a number of Spatial Domain, SD, basis vectors to be selected from CSI Reference Signal, CSI-RS, resource n, and the number of SD basis vectors to be selected across all the CSI-RS resources is given by {L₁, . . . , L_{N}_{_{TRP}}}, where N_{TRP} is the number of Transmission/Reception Points, TRPs.
Embodiment 18: The method of embodiment 16 or 17 wherein a parameter β is configured together with each {Lₙ, n=1, . . . , N_{TRP}} hypothesis.
Embodiment 19: The method of embodiment 16 or 17 wherein both parameters β and pᵥ are configured together with each {Lₙ, n=1, . . . , N_{TRP}} hypothesis.
Embodiment 20: The method of embodiment 16 or 17 further comprising sending (1506), to the UE (1502), information that configures the UE (1502) with parameter β and/or parameter pᵥ, separately from the information that configures the UE (1502) with the parameter combination list.
Embodiment 21: The method of any of embodiments 16 to 20 wherein the information that configures the UE (1502) with the parameter combination list comprises the parameter combination list.
Embodiment 22: The method of any of embodiments 16 to 20 wherein the information that configures the UE (1502) with the parameter combination list comprises an index or value that is mapped to the parameter combination list (e.g., via a predefined or configured table).
Embodiment 23: The method of any of embodiments 16 to 22 wherein the information that configures the UE (1502) with the parameter combination list is part of a CSI-AperiodicTriggerStateList IE.
Embodiment 24: The method of embodiment 23 wherein the number of combinations or hypotheses in the parameter combination list corresponding to each of multiple CSI-AssociatedReportConfigInfo's included in the CSI-AperiodicTriggerStateList IE is the same.
Embodiment 25: The method of embodiment 23 wherein the number of combinations or hypotheses in the parameter combination list corresponding to each of multiple CSI-AssociatedReportConfigInfo's included in the CSI-AperiodicTriggerStateList IE is different. Embodiment 26: The method of any of embodiments 16 to 22 wherein the information that configures the UE (1502) with the parameter combination list is part of a CSI-SemiPersistentOnPUSCH-TriggerState.
Embodiment 27: The method of any of embodiments 16 to 22 wherein the information is for configuration of CJT CSI for semi-persistent CJT CSI report on PUSCH triggered or activated by DCI format 0_1 or DCI format 0_2, and the information that configures the UE (1502) with the parameter combination list is part of a CSI-SemiPersistentOnPUSCH-TriggerState associated to a CJT CSI report configuration.
Embodiment 28: The method of any of embodiments 16 to 22 wherein the information that configures the UE (1502) with the parameter combination list is part of a CodebookConfig IE.
Embodiment 29: The method of any of embodiments 16 to 22 wherein the information that configures the UE (1502) with the parameter combination list is part of a codebook configuration within a CJT CSI report configuration.
Embodiment 30: The method of any of the previous embodiments, further comprising: obtaining user data; and forwarding the user data to a host or a user equipment.

### Group C Embodiments

Embodiment 31: A user equipment comprising: processing circuitry configured to perform any of the steps of any of the Group A embodiments; and power supply circuitry configured to supply power to the processing circuitry.
Embodiment 32: A network node comprising: processing circuitry configured to perform any of the steps of any of the Group B embodiments; and power supply circuitry configured to supply power to the processing circuitry.
Embodiment 33: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Embodiment 34: a host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.
Embodiment 35: the host of the previous embodiment, wherein the cellular network further includes a network node configured to communicate with the UE to transmit the user data to the UE from the host.
Embodiment 36: The host of the previous 2 embodiments, wherein: the processing circuitry of the host is configured to execute a host application, thereby providing the user data; and the host application is configured to interact with a client application executing on the UE, the client application being associated with the host application.
Embodiment 37: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.
Embodiment 38: The method of the previous embodiment, further comprising: at the host, executing a host application associated with a client application executing on the UE to receive the user data from the UE.
Embodiment 39: The method of the previous embodiment, further comprising: at the host, transmitting input data to the client application executing on the UE, the input data being provided by executing the host application, wherein the user data is provided by the client application in response to the input data from the host application.
Embodiment 40: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
Embodiment 41: The host of the previous embodiment, wherein the cellular network further includes a network node configured to communicate with the UE to transmit the user data from the UE to the host.
Embodiment 42: the host of the previous 2 embodiments, wherein: the processing circuitry of the host is configured to execute a host application, thereby providing the user data; and the host application is configured to interact with a client application executing on the UE, the client application being associated with the host application.
Embodiment 43: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.
Embodiment 44: The method of the previous embodiment, further comprising: at the host, executing a host application associated with a client application executing on the UE to receive the user data from the UE.
Embodiment 45: The method of the previous embodiment, further comprising: at the host, transmitting input data to the client application executing on the UE, the input data being provided by executing the host application, wherein the user data is provided by the client application in response to the input data from the host application.
Embodiment 46: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
Embodiment 47: The host of the previous embodiment, wherein: the processing circuitry of the host is configured to execute a host application that provides the user data; and the UE comprises processing circuitry configured to execute a client application associated with the host application to receive the transmission of user data from the host.
Embodiment 48: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.
Embodiment 49: The method of the previous embodiment, further comprising, at the network node, transmitting the user data provided by the host for the UE.
Embodiment 50: The method of any of the previous 2 embodiments, wherein the user data is provided at the host by executing a host application that interacts with a client application executing on the UE, the client application being associated with the host application.
Embodiment 51: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
Embodiment 52: The communication system of the previous embodiment, further comprising: the network node; and/or the user equipment.
Embodiment 53: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
Embodiment 54: The host of the previous 2 embodiments, wherein: the processing circuitry of the host is configured to execute a host application, thereby providing the user data; and the host application is configured to interact with a client application executing on the UE, the client application being associated with the host application.
Embodiment 55: The host of the any of the previous 2 embodiments, wherein the initiating receipt of the user data comprises requesting the user data.
Embodiment 56: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.
Embodiment 57: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a network node, information that configures the UE with a parameter combination list consisting of one or more combinations or hypotheses of values for {L₁, . . . , L_{N}_{_{TRP}}} for a respective set of Channel State Information Reference Signal (CSI-RS) resources {CSI-RS resource 1, . . . , CSI-RS resource N_{TRP}} configured for the UE for Channel State Information (CSI) feedback corresponding to Coherent Joint Transmission (CJT) wherein Lₙ (n=1, . . . , N_{TRP}) is a number of spatial domain (SD) basis vectors to be selected by the UE from CSI-RS resource n; and
generating and reporting CSI, in accordance with the received information.

2.-37. (canceled)
